(19) United States
(12) Patent Application Publication
(10) Pub. No.: US 2015/0332269 A1
(43) Pub. Date: Nov. 19, 2015

(54) SYSTEMS AND METHODS FOR DEBIT CARD ACCOUNT CONFIRMATION

(71) Applicant: FISERV, INC., Brookfield, WI (US)

(72) Inventors: Carol Jackie Lucia Specogna, Bellingham, WA (US); David Michael Keenan, Wilmette, IL (US); Kevin Gilbert, Mukwonago, WI (US); Annmarie D. Hart, Manhattan Beach, CA (US); Roger W. Applewhite, Palos Verdes Estates, CA (US)

(21) Appl. No.: 14/720,040

(22) Filed: May 22, 2015

Related U.S. Application Data
(63) Continuation of application No. 13/791,101, filed on Mar. 8, 2013, now abandoned.

(51) Int. Cl. G06Q 20/40; G06Q 20/38; G06Q 20/26

(52) U.S. Cl. CPC G06Q 20/409; G06Q 20/26; G06Q 20/385

(57) ABSTRACT

Systems and methods that receive one or more information associated with a debit card account and receive verification of the information associated with the debit card. Upon the verification, a proxy associated with the information may be generated and stored in association with the information. The proxy may further be provided to other entities that may use the proxy as an indicator of the verification of the debit card account and for initiating transactions using the verified debit card account.

### CROSS REFERENCE TO RELATED APPLICATION(S)

This application is a continuation of U.S. application Ser. No. 13/791,101, filed Mar. 8, 2013, the content of which is incorporated by reference herein in its entirety.

### FIELD OF THE DISCLOSURE

The present disclosure relates to systems and methods for debit card account confirmation.

### BACKGROUND OF THE DISCLOSURE

Users (who may be merchants or consumers) may desire to initiate financial transactions using their client devices such as mobile devices. These financial transactions may involve credits and/or debits and may be performed using a debit card. The use of the debit card to perform a financial transaction may require the user to provide information associated with the debit card such a personal account number (“PAN”) and/or a personal identification number (“PIN”). Such information may be sensitive information that enables others to use the debit card account if they are in possession of the card and/or the PAN in a fraudulent manner. The legitimate association of the user with the preferred PAN may further need to be confirmed before the account may be used for performing financial transactions. Furthermore, a separation of storage of information regarding the user and information regarding the account for heightened security may require coordination when performing financial transactions.

### BRIEF DESCRIPTION OF THE FIGURES

Reference will now be made to the accompanying drawings, which are not necessarily drawn to scale, and wherein:

FIG. 1 is a simplified schematic diagram illustrating an example architecture for debit account confirmation in accordance with illustrative embodiments of the disclosure.

FIG. 2 is a simplified schematic diagram illustrating an example client application back-end server as part of the example architecture of FIG. 1 in accordance with illustrative embodiments of the disclosure.

FIG. 3 is a simplified schematic diagram illustrating an example PAN/PIN vault server as part of the example architecture for debit card account confirmation of FIG. 1 in accordance with illustrative embodiments of the disclosure.

FIG. 4 is a simplified interaction chart illustrating an example set of interactions to perform debit card account confirmation in accordance with illustrative embodiments of the disclosure.

FIGS. 5A, 5B, and 5C are a flow diagram illustrating an example method for performing debit card account confirmation in accordance with illustrative embodiments of the disclosure.

FIGS. 6A and 6B are a flow diagram illustrating an example method for debit card account confirmation in accordance with illustrative embodiments of the disclosure.

FIGS. 7A and 7B are a flow diagram illustrating an example method for debit card account confirmation in accordance with illustrative embodiments of the disclosure.

FIGS. 8A, 8B, and 8C is a flow diagram illustrating an example method for performing a financial transaction using confirmed debit card account information in accordance with illustrative embodiments of the disclosure.

### DETAILED DESCRIPTION OF EMBODIMENTS OF THE DISCLOSURE

Embodiments of the disclosure are described more fully hereinafter with reference to the accompanying drawings, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

Embodiments of the disclosure may provide systems and methods for debit card account confirmation and storage of confirmed and/or valid information associated with the confirmed debit card. Once the debit card has been confirmed, embodiments of the disclosure may further enable a user to interact with a client application user interface and/or client application back-end servers to initiate transactions using the verified and confirmed debit card.

The debit card confirmation may entail a remote server such as a PAN/PIN vault server receiving debit card related information such as a personal account number (PAN) and/or a personal identification number (PIN). The PAN/PIN vault servers may be configured to receive the debit card related information from the one or more a variety of user interfaces such as a client application user interface (UI), a PAN entry user interface (UI), and/or a PIN entry user interface (UI). The user may interact with one or more of the client application user interface, the PAN entry user interface and/or the PIN entry user interface to initiate a confirmation of the debit card account associated with the user and/or to enter information associated with the debit card of the user.

The PAN/PIN vault servers may, in certain embodiments, receive a PAN entry associated with a particular debit card account from a PAN entry user interface and based thereon, generate a one-time code. The one-time code, in some cases, may be a hash, such as a one-way hash, of the received PAN entry. The PAN/PIN servers may then transmit the one-time code to a client application back-end server, or to an entity that can transmit the one-time code to the client application back-end server. The client application back-end server may identify a mechanism for communicating to the user, and may use that mechanism to notify the user of the one-time code, and optionally instructions for performing PIN entry, via a PIN entry user interface. The PIN entry user interface may then interact with the user to receive a PIN from the user. The interaction may entail the PIN entry user interface soliciting the PIN from the user. Once the PIN entry user interface receives the PIN from the user, such as by the user keying in the PIN, the PIN entry user interface may transmit the entered PIN in association with the one-time code, to the PAN/PIN vault servers. The PAN/PIN vault servers may then be able to associate the received PIN with the previously received PAN using the generated one-time code.

The PAN/PIN vault servers upon receiving information associated with the debit card, such as the PAN and/or the PIN, may generate a debit card verification request, including the received debit card information, such as the PAN and/or PIN information, to verify if the received debit card information is valid. The PAN/PIN vault servers may perform the debit card account confirmation in cooperation with one or more entities, such as debit card processing servers. In other words, the PAN/PIN vault servers may transmit the generated debit card verification request to the debit card processing servers. The debit card processing servers may perform the verification of the debit card information as received with the debit card verification request and transmit a verification response indicative of the verification of the debit card information. The PAN/PIN vault servers may receive the verification response and determine if the debit card information provided in the generated verification request is valid.

Upon a positive confirmation of the validity of the information associated with the user's debit card account, the PAN/PIN vault servers may generate and associate a PAN proxy with PAN and/or PIN information of the debit card account. The PAN proxy may, in certain embodiments, be a hash, such as a one-way hash, of the confirmed PAN and/or PIN information associated with the debit card. This association of the PAN and/or PIN with the PAN proxy may be stored in one or more databases accessible by the PAN/PIN vault servers.

The PAN/PIN vault servers may further transmit the PAN proxy to the client application back-end servers, either directly or indirectly, and the client application back-end servers may store the PAN proxy in association with an identification of the user. In certain embodiments, the PAN/PIN vault servers may transmit the PAN proxy associated with the user and/or the user's debit card account to the client application user interface, either directly or indirectly. The client application user interface, in turn, may provide the PAN proxy, along with an indication of the user's identity to the client application back-end servers. The client application back-end servers, therefore, may receive both an identification of the user, along with the PAN proxy, from the client application user interface.

Upon confirmation of the debit card account information, the client application back-end servers may not store the PAN or PIN information associated with the debit card account. Additionally, the user interfaces such as the client application user interface, the PAN entry user interface, and the PIN entry user interface, and hardware and/or software associated therewith, may also not store the PAN or PIN information associated with the debit card account of the user. The PAN/PIN vault servers, on the other hand, may store the PAN proxy association with PAN and/or PIN information of the debit card, but not an identification of the user. Therefore, no single entity may have all of the PAN, PIN, PAN proxy, and user identity information, providing a relatively high level of financial information security associated with the debit card account information.

When a user wishes to initiate a transaction using his or her debit card account, he or she may interact with the client application back-end servers via his or her client application user interface. In this case, the client application user interface may be supported by a personal electronic device or client device, such as a laptop computer, a desktop computer, a smartphone, an e-book reader, a tablet computing device, or the like, with instructions and/or application(s) running thereon. In other words, the client application user interface may be provided by one or more applications operating on a client device, such as a client device associated with the user. In some cases, the one or more applications may enable a thin client configuration where the user may interact with another entity, such as the client back-end servers via the one or more applications, such as a web browser. The user may provide, via the client application user interface, authentication information to the client application back-end servers to identify himself/herself to the client application back-end servers. Upon identifying the user, the client application back-end servers may access one or more databases that associate a PAN proxy with the identity of the user. Based, at least in part, on the identity of the user as determined by the client application back-end servers and based, at least in part, on information, such as PAN proxy association information, stored in a user association database, the client application back-end server may determine a PAN proxy associated with the user and the debit card the user wishes to use to make a financial transaction.

The client application back-end servers may generate and transmit a network transaction request associated with the debit card account of the user on behalf of the user based on information that the user may provide to the client application back-end servers via his or her client application user interface. The transaction request as generated by the client application back-end serves may include a PAN proxy as well as other information such as a transaction amount requested by the user on his or her debit card account. Therefore, the transaction request as generated by the client application back-end servers does not include a PAN or a PIN associated with the debit card account of the user. The transaction request may be received by the debit card processing servers via one or more communicative links between the client application back-end servers and the debit card processing servers.

The debit card processing servers may recognize that the transaction request includes the PAN proxy and not the PAN and PIN information and, therefore, transmit the transaction request to the PAN/PIN vault servers. The PAN/PIN vault servers may receive the transaction request from the debit card processing servers via one or more communicative links and determine the PAN proxy associated with the user and the debit card account from the received transaction request. The PAN/PIN vault servers may access a database associating PAN proxies and PAN/PIN information and retrieve a PAN and/or a PIN associated with the PAN proxy received with the transaction request from the debit card processing servers. The PAN/PIN vault servers may then modify the received transaction request and/or generate a new transaction request based upon the received transaction request. The transaction request provided by the PAN/PIN vault servers which may be a modification of the transaction request received from the debit card processing servers may include a PAN and/or PIN associated with the debit card and the user and not include the PAN proxy associated with the debit card and/or the user.

The modified transaction request may be transmitted to the debit card processing servers via one or more communicative links between the PAN/PIN vault servers and the debit card processing servers. The debit card processing servers upon receiving the modified transaction request, including the PAN and/or PIN information associated with the debit card and/or the user, from the PAN/PIN vault servers, may initiate a transaction associated with the received transaction request. In this case, the transaction may involve transacting an amount associated with the user's requested transaction amount using the PAN and/or PIN information as provided by the PAN/PIN vault servers in the modified transaction request as received by the debit card processing servers.

The debit card processing servers upon initiating the transaction request may receive confirmation of the transaction request being fulfilled. Upon receiving confirmation, the debit card processing servers may generate a transaction response including the PAN and/or PIN associated with the debit card and the user. This may include transmitting and/or propagating the received transaction request. The debit card processing servers may transmit the transaction response via one or more communicative links to the PAN/PIN vault servers.

The PAN/PIN vault servers may receive the transaction response and, based thereon, determine the PAN and/or PIN associated with the transaction that transpired. The PAN/PIN vault servers may then access the database of PAN/PIN information association with PAN proxy. Using the database and associations therein, the PAN/PIN vault servers may determine a PAN proxy associated with the PAN and/or PIN information as ascertained from the transaction response received from the debit card processing servers. The PAN/PIN vault servers may then generate a transaction response that includes the PAN proxy and not the PAN or PIN information associated with the user and his or her debit card. The PAN/PIN vault servers may then transmit the transaction response to the client application back-end servers, which may, in turn, determine the user with whom the transaction is associated by accessing the database associating users and/or debit card accounts with their corresponding PAN proxy, as provided in the transaction response received from the PAN/PIN vault servers. The PAN/PIN vault servers may transmit the transaction response to the client back-end servers via either a direct or indirect route.

Based upon determining the user associated with the transaction response, the client application back-end servers may generate a confirmation of the transaction and transmit an indication of that confirmation to the client application user interface for rendering to the user who requested the transaction using his or her debit card account.

Therefore, it can be seen that the PAN/PIN vault servers may have access to PAN and/or PIN information associated with the debit card, associated with a PAN proxy but without access to the identity of the user associated with that PAN or PIN. The client application back-end servers, on the other hand, may have access to an association between a PAN proxy and a user without having access to a PAN or PIN associated with the user or the debit card account. Therefore, no one entity has all the information identifying the user, the debit card account, the PAN and the PIN. Therefore, relatively secure transactions may transpire without compromising security associated with multiple entities having access to the PAN and/or the PIN associated with user debit accounts. Furthermore, the confirmation of the debit account is also performed with no one entity having all information associated with the debit card account.

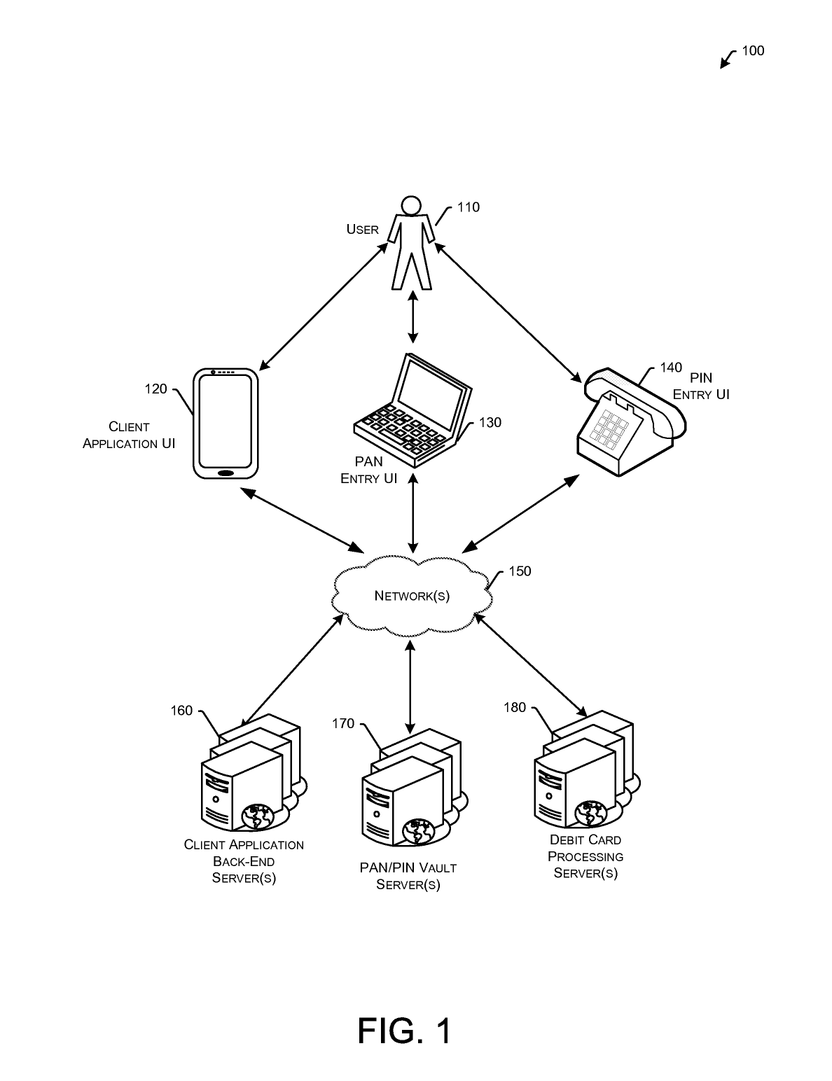

Referring now to FIG. 1, an example of architecture 100 for performing debit card account confirmation is described. A user 110 may be able to interact with a variety of user interfaces such as a client application user interface (UI) 120, a PAN entry user interface (UI) 130, and/or a PIN entry user interface (UI) 140. Each of these user interfaces 120, 130, 140 may further be configured to communicate via one or more networks 150, with one or more client application back-end server(s) 160, and/or one or more PAN/PIN vault server(s) 170, as appropriate. The client application back-end server(s) 160 and/or the PAN/PIN vault server(s) 170 may, in turn, be configured to communicate via one or more networks 150 with one or more debit card processing server(s) 180 to perform debit account confirmation as well as initiate financial transactions. It should be noted that, while the client application back-end serve(s) 160, PAN/PIN vault server(s) 170, and debit card processing server(s) 180 are shown as distinct from each, various scopes of functionality may be hosted by separate entities or a same entity, as well as distributed across different platforms or co-located on a same platform.

The user 110 may be any individual and/or entity that wishes to use a debit card account to perform a financial transaction such as a payment or a deposit of funds to the debit card account. The user 110 may be any one of an individual, a corporation, an organization, a for-profit organization, a non-profit organization, or combinations thereof.

The client application user interface 120 may be provided as part of a client device as depicted, such as the client device with a user interface application and/or software operating thereon. Therefore, a user 110 may access the client application user interface 120 as part of an electronic device, such as a laptop computer, a server computer, a desktop computer, a netbook computer, a tablet computing device, an e-book reader and/or a smartphone. In some embodiments, the client application user interface 120 may be supported by one or more server platforms as well as the client device.

The PAN entry user interface 130 may also be on an electronic device with input/output components with which the user 110 may interact to provide a PAN on the PAN entry user interface 130. The PAN entry user interface may be provided as part of any electronic device such as a personal electronic device of the user 110. The PAN entry user interface 130 may be part of a laptop computer, a netbook computer, a server computer, a desktop computer, a tablet computer, an e-book device, a smartphone and/or a telephone. In some embodiments, the PAN entry user interface 130 may be supported by one or more server platforms as well as the client device.

The PIN entry user interface 140 may be a variety of electronic devices or client devices such as personal electronic devices of the user 110. The PIN entry user interface may be any one of a laptop computer, a netbook computer, a server computer, a desktop computer, a tablet computing device, an e-book reader, a smartphone and/or a telephone. In some embodiments, the PIN entry user interface 140 may be supported by one or more server platforms as well as the client device.

In certain embodiments, one or more of the user interfaces 120, 130 and 140, may be supported by the same device, such as a client device. For example, a user 110 may enter the PAN and the PIN of his or her debit card using the same device, such as a smartphone, and therefore, the PAN entry user interface 130 and the PIN entry user interface 140 may be supported by the same client device. It should be appreciated that in certain embodiments where the PAN and/or the PIN are numeric information, the PAN entry user interface 130 and/or the PIN entry user interface 140 may only have mechanisms for numeric entry, such as a telephone.

In certain other cases, the PAN entry user interface 130 and/or the PIN entry user interface 140 may include a card reader or card swipe reader that may be configured to read the PAN, PIN, or other information associated with the debit card from one or more encoding of the information on the debit card, such as on a magnetic strip of the debit card. The card reader may be communicatively attached to a client device that hosts one or both of the PAN entry user interface 130 and/or the PIN entry user interface 140. The PAN, PIN, or other information as read using the card reader may be provided to the PAN entry user interface 130, the PIN entry user interface 140, and/or application(s) associated therewith. In some cases, the PAN and/or PIN information as read using the card reader may be encrypted and the PAN entry user interface 130, PIN entry user interface 140, or other entities with which the PAN entry user interface 130 communicates may be configured to decrypt the encrypted information. It should also be noted that in some cases, the debit card related information as read by the card reader associated the PAN entry user interface 130 and/or the PIN entry user interface 140 may be configured to transmit the information to the PAN/PIN vault servers 170, either directly or indirectly. In some cases, the PAN entry user interface 130 and/or the PIN entry user interface 140 may be configured to transmit the debit card related information via on or more of the client application user interface 120 or the debit card processing servers 180.

In certain other embodiments, the client application user interface 120 may be supported by the same device supporting the PAN entry user interface 130. In certain other embodiments, all three user interfaces 120, 130 and 140 may be supported by the same client device of the user 110 and may be configured to interact with other elements of architecture 100 and perform the functions of accepting a PAN entry from the user 110 and/or accepting a PIN entry from the user 110.

The networks 150 may include any one of a combination of different types of suitable communications networks, such as cable networks, the internet, wireless networks, cellular networks and other private and/or public networks. Furthermore, the networks 150 may include any variety of medium over which network traffic is carried, including but not limited to, coaxial cable, twisted wire pair, optical fiber, hybrid fiber coaxial, HFC, microwave, terrestrial transceivers, radio frequency communications, satellite communications or combinations thereof.

The client application back-end servers 160 may be configured to interact with the client application user interface 120 to receive and process a variety of requests, including a request to initiate a transaction on the user's debit card account and/or a request to initiate a confirmation of the user's debit card account. The client application user interface 120 may be configured to initiate such requests based on user input, as well as present associated information and transaction options to the user 110. Therefore, the client application back-end servers 160 may receive the confirmation request from the client application user interface, either directly or indirectly, such as via the networks 150 on behalf of the user 110 for establishing his or her debit card account as a mechanism for payments and/or receiving payments.

The client application back-end servers 160 may further be configured to establish an account with authentication credentials, wherein authentication credentials provided to the client application back-end servers 160 by the user 110 via his or her client application user interface 120 may enable the client application back-end servers 160 to identify the user 110. These authentication credentials may include one or more of a login, password, images, sounds, biometric data (fingerprints, retinal scans, voice recognition, etc.), or the like.

The client application back-end servers 160 may further be configured to receive a PAN proxy associated with a PAN and/or PIN of the user's debit card account from the PAN/PIN vault servers 170 via the networks 150 or other communicative links. When the PAN proxy associated with the user and the debit card account of the user 110 is received by the client application back-end servers 160 for storing in association with the identity of the user 110, it may indicate that the debit card account of the user 110 has been confirmed by one or more other entities of the architecture 100, such as the PAN/PIN vault servers 170 and/or the debit card processing servers 180.

The client application back-end servers may yet further be configured to store the PAN proxy associated with the user and the user's debit card account in association with the identity of the user 110. The association of the user 110 identity and the PAN proxy of the user 110 and the debit card account of the user 110 may be accessed using authentication credentials provided by the user 110 via the client application user interface 120 using his or her client device. Therefore, the client application back-end servers 160 may not store the PAN or PIN information associated with the user and/or the debit card account of the user 110.

The client application back-end servers 160 may still further be configured to receive a transaction request from the client application user interface 120 on behalf of the user 110 and generate a debit network transaction request based thereon and transmit the same to one or more of the debit card processing servers 180 and/or the PAN/PIN vault servers 170. The client application back-end servers 160 may generate the debit network transaction request with information associated with the transaction request, such as the transaction amount and an identification of the user. The client application back-end servers 160 may be enabled to access a database comprising PAN proxies, such as one stored in an external database, associated with users and determine a PAN proxy associated with a received payment request with the identification of the user 110. Based on the debit network transaction request, the PAN/PIN vault servers 170 and the debit card processing servers 180 may cooperate to instantiate the debit network transaction associated with the debit network transaction request and provide confirmation to the client application back-end servers 160.

The client application back-end servers 160 may also be configured to receive a debit network transaction response that includes the PAN proxy associated with the debit network transaction performed. Based on the PAN proxy and by accessing the database comprising an association of PAN proxies to user identities, the client application back-end servers 160 may be configured to provide confirmation of the execution of the requested financial transaction to the user 110 via his or her client application user interface 120.

The PAN/PIN vault servers 170 may be configured to provide various functionalities associated with the debit card account confirmation and subsequent transaction processing. The PAN/PIN vault servers 170 may be configured to store a PAN and/or PIN corresponding to a debit card account in association with a PAN proxy. In this case, the PAN/PIN vault servers 170 may not have information associated with the identity of the user 110 associated with the PAN/PIN and/or PAN proxy information of the user's debit card account.

The PAN/PIN vault servers may further be configured to cooperate with the client application back-end servers 160 and the debit card processing servers 180, as well as other entities of architecture 100, to instantiate a financial transaction on behalf of the user 110 with relatively high security of the transaction via the user's debit card account.

In the process of debit card account confirmation, the PAN/PIN vault servers 170 may be configured to receive a PAN from the PAN entry user interface 130 via the networks 150 or other suitable communicative links. Upon receiving the PAN entry from the PAN entry user interface 130, the PAN/PIN vault servers 170 may be configured to generate and transmit a one-time code associated with the entered PAN directly or indirectly to the client application back-end servers 160, for storage in association with the user and ultimately for communication to the user.

The PAN/PIN vault servers 170 may further be configured to receive a PIN entry in association with the one-time code issued by the PAN/PIN vault servers from the PIN entry user interface 140. Therefore, based upon the PIN entry associated with the one-time code received by the PAN/PIN vault servers 170, the PAN/PIN vault servers 170 may be configured to associate a PAN previously received from the PAN entry user interface 130 and stored in association with the one-time code with a PIN received from the PIN entry user interface 140.

Once a PAN/PIN association has been established by the PAN/PIN vault servers 170, the PAN/PIN vault servers 170 may be configured to request an authentication of the PAN and PIN information of the debit card account of the user 110 from the debit card processing servers 180. The debit card processing servers 180 may provide a response indicating the success or failure of the authentication of the PAN/PIN information provided by the PAN/PIN vault servers 170. The PAN/PIN vault servers 170 may be configured to receive the authentication response via the networks 150 or other suitable communicative links. Upon receipt of a positive authentication by the PAN/PIN vault servers 170, the PAN/PIN vault servers 170 may be configured to generate a PAN proxy associated with the one-time code and/or the PAN or PIN information of the debit card account of the user 110. The PAN proxy may be unique among all the PAN proxies generated and vaulted by the PAN proxy vault servers 170. The PAN proxy may be unambiguously associated with a particular set of debit card information (PAN and/or PIN) associated with a particular user 110 or a particular client application user interface 120 and PAN combination. The PAN proxy may be generated by the PAN/PIN vault servers 170 by performing a hash of the PAN and/or PIN information associated with the debit card account. In other cases, the PAN proxy may be assigned based, at least in part, on the storage of the same in the PAN association database, such as based on a database index. The PAN proxy may indicate that the associated debit card information (PAN and/or PIN) have been confirmed.

The PAN/PIN vault servers 170 may be configured to store the PAN and PIN information of the debit card account that has been authenticated by the debit card processing servers 180 in association with the PAN proxy generated by the PAN/PIN vault servers 170. In some cases, the PAN/PIN vault servers 170 may be configured to store the PAN proxy association with the PAN/PIN information of the debit card account in an external database of the PAN/PIN vault servers 170.

The PAN/PIN vault servers 170, after associating the PAN proxy with the PAN and/or PIN information of the debit card account, may be configured to communicate the PAN proxy in association with the one-time code to one or more other entities of the architecture 100. Ultimately, the PAN proxy and one-time code information may be received by the client application user back-end servers 160. Upon receipt of the PAN proxy and one-time code, the client application back-end servers 160 may be configured to store the PAN proxy in association with the user associated with the one-time code. The PAN proxy may indicate that the debit card account has been confirmed and is now eligible for use; the one-time code may now be discarded.

The debit card processing servers 180 may comprise a gateway to a debit card network for verification and/or transaction purposes. The debit card processing servers may be associated with any variety of debit card networks such as ACCEL®/Exchange, NYCE®, Pulse®, Star®, MasterCard® or Visa®.

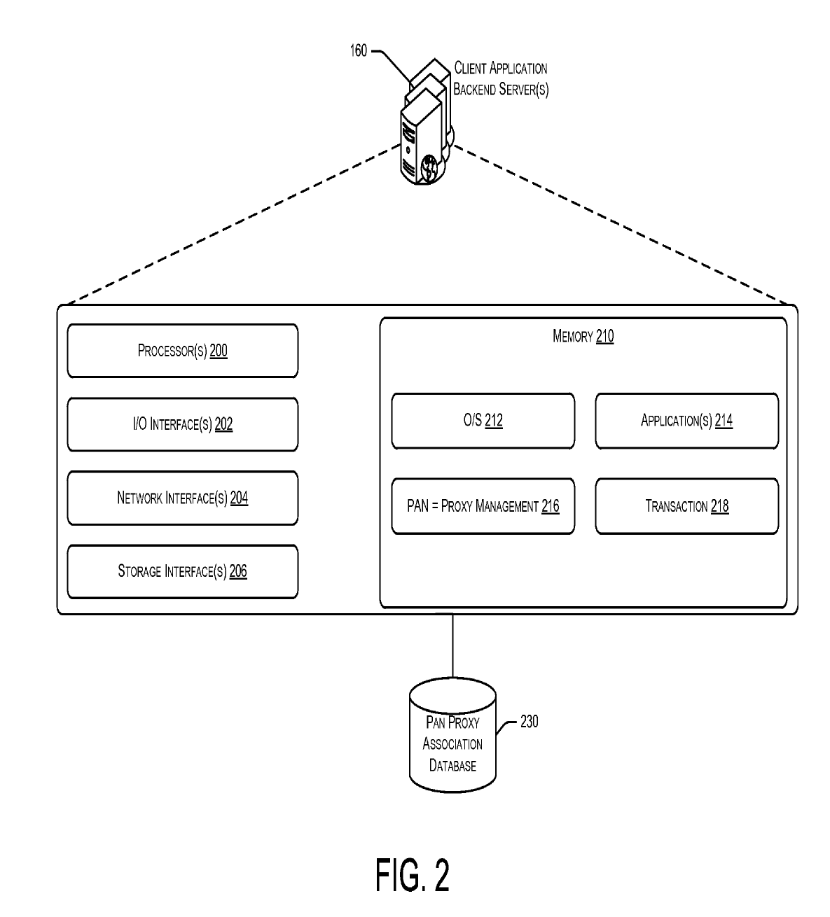

Referring now to FIG. 2. An example of configuration of the client application back-end servers 160 is in accordance with embodiments of the disclosure is discussed. The client application back-end servers 160 may include one or more processors 200, one or more input/output (I/O) interfaces 202, one or more network interfaces 204, one or more storage interfaces 206, and one or more memories.

The one or more processors 200 may be configured to execute and/or operate one or more instructions, applications, and/or software in one or more memories 210 of the client application back-end servers 160 to provide services to the users 110 associated with debit card account confirmation. In some examples, the one or more processors 200 of the client application back-end servers 160 may be implemented as appropriate in hardware, software, firmware, or combinations thereof. Software or firmware implementations of the one or more processors 200 may include computer-executable or machine-executable instructions written in any suitable programming language to perform the various functions described. Hardware implementations of the processors 200 may be configured to execute computer-executable or machine-executable instructions to perform the various functions described. The one or more processors 200 may include, without limitation, a central processing unit (CPU), a digital signal processor (DSP), a reduced instruction set computer (RISC), a complex instruction set computer (CISC), a microprocessor, a microcontroller, a field programmable gate array (FPGA), or any combination thereof. The client application back-end servers 160 may also include a chipset (not shown) for controlling communications between the one or more processors 200 and one or more of the other components of the user device 110. The one or more processors 200 may also include one or more application specific integrated circuits (ASICs) or application specific standard products (ASSPs) for handling specific data processing functions or tasks.

The I/O interfaces(s) 202, may include any suitable interface configured to interface between the processors 200 and input/output components of the client application back-end servers 160. The communications interfaces(s) 204 may allow the client application back-end servers 160 to communicate with stored databases, other computing devices or servers, user terminals, and/or other devices on the networks 150 or other suitable communicative channels. The one or more storage interfaces 206 may enable the client application back-end servers 160 and the processors 200, thereon, to communicate with one or more external storage devices, such as a PAN association database 230.

The memory 210 may include one or more volatile and/or non-volatile memory devices including, but not limited to, random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read only memory (EEPROM), non-volatile RAM (NVRAM), universal serial bus (USB) removable memory, or combinations thereof. The memory 210 may store program instructions that are loadable and executable on the processor(s) 200, as well as data generated or received during the execution of these programs. Turning to the contents of the memory 210 in more detail, the memory 210 may include an operating system (0/S) module 212, applications module 214, a PAN proxy management module 216, and a transaction module 218. Each of the modules and/or software may provide functionality for the client application back-end servers 160, when executed by the processors 200. The modules and/or the software may or may not correspond to physical locations and/or addresses in memory 210. In other words, the contents of each of the modules may not be segregated from each other and may, in fact be stored in at least partially interleaved positions on the memory 210. In certain embodiments, each of the modules 212, 214, 216, 218 may be divided with greater granularity. In other words, each of the modules 212, 214, 216, 218 may include sub-modules.

The O/S module 212 may have one or more operating systems stored thereon. The processors 200 may be configured to access and execute one or more of the O/S module 212 to operate the system functions of the client application back-end servers 160. System functions, as managed by the O/S 212 may include memory management, processor resource management, driver management, application software management, system configuration, and the like. The O/S may be any variety of suitable operating systems including, but not limited to, Google® Android®, Microsoft® Windows®, Microsoft® Windows® Server®, Linux, Apple® OS-X®, Apple® iOS®, or the like. In other words, the O/S 212 may be the framework under which the merchant 110 may interact with the client application back-end servers 160. The applications module 214 may have one or more software applications stored thereon that may be accessed and executed by the processors 200 to provide various functionality of the client application back-end servers 160, including remote deposit related functionality.

The PAN proxy management module 216 may have instructions stored thereon, that when executed by the processors 200 enable the client application back-end servers 160 to perform a variety of functions associated with receiving and managing a PAN proxy associated with a particular user 110 and his or her debit card account. In one aspect, processors 200 may receive a PAN proxy from one or more elements of architecture 100 such as from the PAN/PIN vault servers 170 via, for example, the PIN entry user interface 140 and/or the client application user interface 120. The processors 200 may be configured to store the PAN proxy associated with a particular user 110 in memory 210 or the PAN association database 230. When the client application back-end server 160 receives an identification of the user 110, the client application back-end servers 160 and the processors 200 thereon, may be configured to retrieve a PAN proxy associated from the PAN association database or a like repository associating PAN proxies and users. The PAN proxies that are stored by the client application back-end servers 160 may be associated with debit cards that have been confirmed by the PAN/PIN vault servers 170.

The transaction module 218 may include instructions, that when executed by the processors 200 enable the client application back-end servers 160 to execute processes that initiate a transaction using a debit card associated with the user 110. The processors 200 may be configured to receive a transaction request from the client application user interface 120 on behalf of the user 110 and transmit a debit network transaction request including a PAN proxy to the debit card processing servers 180 to instantiate a debit network transaction based upon the debit network transaction request.

The processors 200 may further be configured to receive authentication credentials associated with the user to identify the user 110. Upon identification, the client application back-end servers 160 and the processors 200 thereon may be configured to receive a variety of possible requests from the user 110, including receive a PAN registration request or a payment request. The PAN registration request may initiate a debit card account confirmation process as described hereinafter, resulting in the storage of a PAN proxy in association with the user 110 upon successful debit card account confirmation. The payment request may initiate a process of retrieving the r PAN proxy associated with the user 110, generating a debit network transaction request comprising the PAN proxy, and transmitting the debit network transaction request to the debit card processing servers 180 via the network 150 to initiate the transaction.

The client application back-end servers 160 may further be configured to receive a confirmation of performing the transaction, such as a transaction response. Based on the transaction response, the processors 200 may further be configured to identify the user 110 associated with the transaction and provide a confirmation of the transaction to the user 110 via his or her client application user interface 120.

It will be appreciated that there may be overlap in the functionality of the instructions stored in the O/S module 212, the applications module 214, the PAN proxy management module 216, and the transaction module 218. In fact, the functions of the four aforementioned modules 212, 214, 216, 218 may interact and cooperate seamlessly under the framework of the client application back-end servers 160. Indeed, each of the functions described for any of the modules 212, 214, 216, 218 may be stored in any other module 212, 214, 216, 218 in accordance with certain embodiments of the disclosure. Further, in certain embodiments, there may be one single module that includes the instructions, programs, and/or applications described within the O/S module 212, the applications module 214, the PAN proxy management module 216, and the transaction module 218.

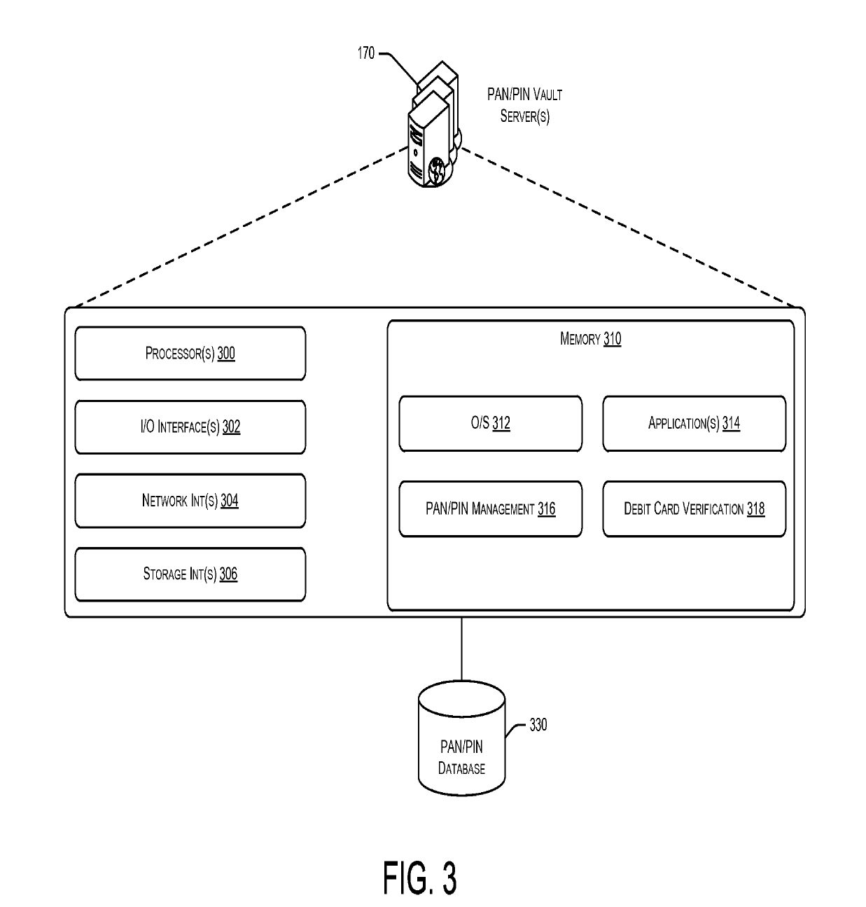

Referring now to FIG. 3, the PAN/PIN vault servers 170 may include one or more processors 300 one or more input/output interfaces 302, one or more network interfaces 304, one or more storage interfaces 306, and/or one or more memories 310.

The one or more processors 300 may be configured to execute and/or operate one or more instructions, applications, and/or software in one or more memories 310 of the PAN/PIN vault servers 170 to provide services to the users 110 associated with debit card account confirmation. In some examples, the one or more processors 300 of the PAN/PIN vault servers 170 may be implemented as appropriate in hardware, software, firmware, or combinations thereof. Software or firmware implementations of the one or more processors 300 may include computer-executable or machine-executable instructions written in any suitable programming language to perform the various functions described. Hardware implementations of the processors 300 may be configured to execute computer-executable or machine-executable instructions to perform the various functions described. The one or more processors 300 may include, without limitation, a central processing unit (CPU), a digital signal processor (DSP), a reduced instruction set computer (RISC), a complex instruction set computer (CISC), a microprocessor, a microcontroller, a field programmable gate array (FPGA), or any combination thereof. The PAN/PIN vault servers 170 may also include a chipset (not shown) for controlling communications between the one or more processors 300 and one or more of the other components of the user device 110. The one or more processors 300 may also include one or more application specific integrated circuits (ASICs) or application specific standard products (ASSPs) for handling specific data processing functions or tasks.

The I/O interfaces(s) 302, may include any suitable interface configured to interface between the processors 300 and input/output components of the PAN/PIN vault servers 170. The communications interfaces(s) 304 may allow the PAN/PIN vault servers 170 to communicate with stored databases, other computing devices or servers, user terminals, and/or other devices on the networks 150 or other suitable communicative channels. The one or more storage interfaces 306 may enable the PAN/PIN vault servers 170 and the processors 300, thereon, to communicate with one or more external storage devices, such as a PAN/PIN database 330.

The memory 310 may include one or more volatile and/or non-volatile memory devices including, but not limited to, random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read only memory (EEPROM), non-volatile RAM (NVRAM), universal serial bus (USB) removable memory, or combinations thereof. The memory 310 may store program instructions that are loadable and executable on the processor(s) 300, as well as data generated or received during the execution of these programs. Turning to the contents of the memory 310 in more detail, the memory 210 may include an operating system (0/S) module 312, applications module 314, a PAN/PIN management module 316, and a debit card verification module 318. Each of the modules and/or software may provide functionality for the PAN/PIN vault servers 170, when executed by the processors 300. The modules and/or the software may or may not correspond to physical locations and/or addresses in memory 310. In other words, the contents of each of the modules may not be segregated from each other and may, in fact be stored in at least partially interleaved positions on the memory 310. In certain embodiments, each of the modules 312, 214, 316, 318 may be divided with greater granularity. In other words, each of the modules 312, 314, 316, 318 may include sub-modules.

The O/S module 312 may have one or more operating systems stored thereon. The processors 300 may be configured to access and execute one or more of the O/S module 312 to operate the system functions of the PAN/PIN vault servers 170. System functions, as managed by the O/S 312 may include memory management, processor resource management, driver management, application software management, system configuration, and the like. The O/S may be any variety of suitable operating systems including, but not limited to, Google® Android®, Microsoft® Windows®, Microsoft® Windows® Server®, Linux, Apple® OS-X®, Apple® iOS®, or the like. The applications module 314 may have one or more software applications stored thereon that may be accessed and executed by the processors 300 to provide various functionality of the PAN/PIN vault servers 170, including remote deposit related functionality.

The PAN/PIN management module 316 may include instructions thereon, that when executed by processors 300 enable the PAN/PIN vault servers 170 to provide a variety of functions related to PAN/PIN management including receiving a PAN and optionally a PIN from the user 110 and providing a PAN proxy associated with the PAN (and optionally PIN) received for a particular debit card of the user 110. In particular, the processors 300 may be configured to receive a PAN on behalf of the user 110 from the PAN entry user interface 130 and store the PAN in the memory 310 or the PAN/PIN database 330. The processors 300 may further be configured to generate a one-time code upon receiving a PAN from the PAN entry user interface 130 and store the one-time code in association with the PAN in the memory 310 or the PAN/PIN database 330. The PAN/PIN vault servers 170 and the processors 300, thereon, may further be configured to transmit the generated one-time code directly or indirectly, e.g., via the PIN entry user interface 140, to the client application back-end servers 160. The processors 300 may further be configured to receive a PIN along with the one-time code issued by the PAN/PIN vault servers 170 from the PIN entry user interface 140 on behalf of the user 110 and store the PIN in association with the PAN (and the one-time code) in the memory 310 or the PAN/PIN database 330. The processors 300 may yet further be configured, by executing instructions in the PAN/PIN management module 316, to generate and store a PAN proxy in association with the PAN, the one-time code, and optionally the PIN. In certain embodiments, the PAN proxy may be a hash of the PAN and/or PIN information. Therefore, the processors 300 may be configured to perform a hash, such as a one-way hash, of the PAN and or PIN, such as a confirmed PAN and/or PIN. In other cases, the PAN proxy may be based, at least in part, on a database storage index, such as an index associated with storage in the PAN/PIN database 330. This PAN proxy may further be transmitted with the one-time code to one or more entities of architecture 100 by the PAN/PIN vault servers 170. Once the PAN proxy and the one-time code have been transmitted, the one-time code may be discarded from the memory 310 or the PAN/PIN database 330. The PAN proxy may indicate to other entities that the information associated with the debit card to be confirmed have indeed been positively confirmed. The PAN proxy may be a fixed length. In some cases, the PAN proxy may be the same fixed length as the PAN with which it is associated. In these or other cases, the PAN proxy may be nine numerical digits in length.

The debit card verification module 318 may have instructions stored thereon that when executed by the processors 300, enable the PAN/PIN vault servers 170 to perform a variety of functions associated with authenticating and/or verifying the debit card information received by the PAN/PIN vault servers 170. Therefore, upon receiving the PAN and/or PIN from the respective user interfaces 130, 140, the processors 300 may generate an authentication request. The authentication request may then be transmitted to the debit card processing servers 180 for verification of the information such as the PAN and/or the PIN associated with a debit card account of the user 110.

The processors 300 may further be configured to receive an authentication response that indicates whether the information associated with the debit card account are valid or not. This authentication response and the indication of validity of the debit card information may be shared with the processes associated with the PAN/PIN management module 316 to further provide a PAN proxy and communicating that PAN proxy to other entities of the architecture 100.

It will be appreciated that there may be overlap in the functionality of the instructions stored in the operating system (0/S) module 312, the applications module 314, the PAN/PIN management module 316, and the debit card verification module 318. In fact, the functions of the four aforementioned modules 312, 314, 316, 318 may interact and cooperate seamlessly under the framework of the payment system 170. Indeed, each of the functions described for any of the modules 312, 314, 316, 318 may be stored in any other module 312, 314, 316, 318 in accordance with certain embodiments of the disclosure. Further, in certain embodiments, there may be one single module that includes the instructions, programs, and/or applications described within the operating system (O/S) module 312, the applications module 314, the PAN/PIN management module 316, and the debit card verification module 318.

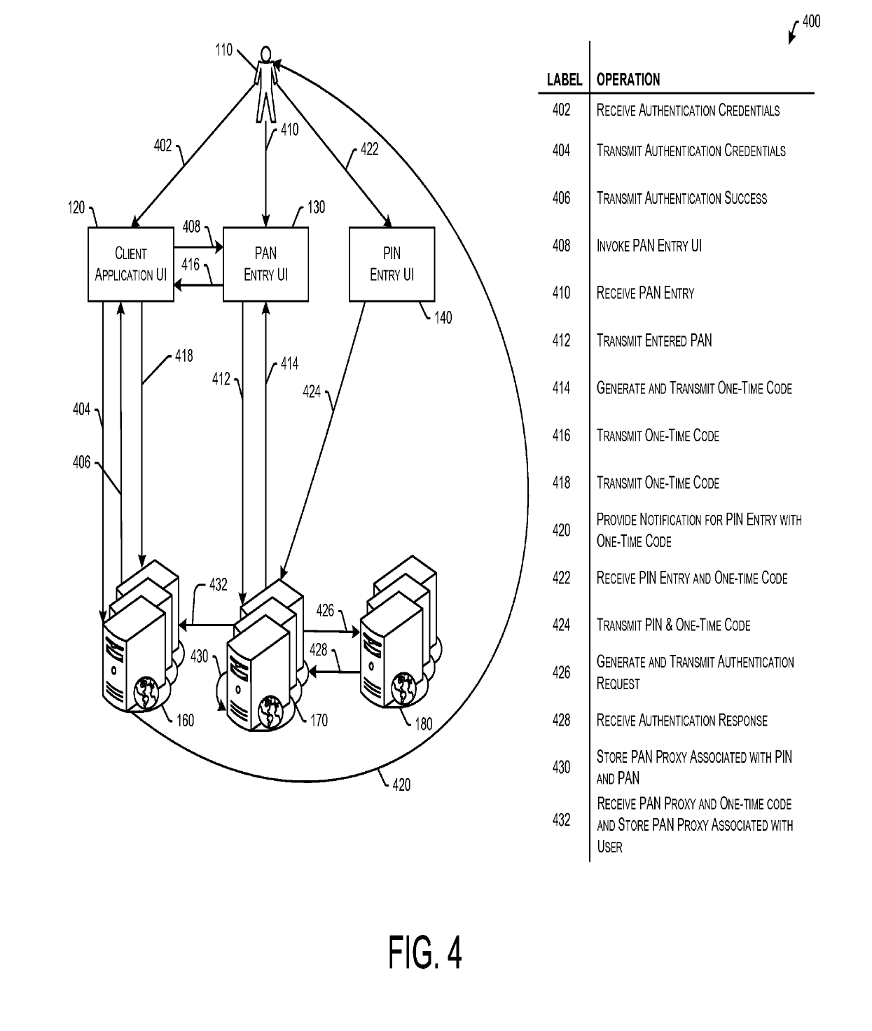

Referring now to FIG. 4, an example interaction mechanism 400 is depicted. Interaction 402 may include the user 110 providing authentication credentials to his or her client application user interface 120. The authentication credentials provided may enable the client application user interface 120 and/or the client application back-end servers 160 to positively identify the user 110. The authentication credentials then may be transmitted 404 from the client application user interface 120 to the client application back-end servers 160. An indication of the authentication success may be transmitted 406 from the client application back-end servers 160 to the client application user interface 120.

The client application user interface 120 may then transmit 408, an indication to invoke the PAN entry user interface 130. The client application user interface may pass an identifier of the client application context in association with the indication, which may ultimately be stored in the PAN/PIN vault servers in association with the PAN, PIN, one-time code, and/or PAN proxy. The PAN entry user interface 130 may, responsive to the invocation from the client application user interface 120, present a prompt for a PAN in a PAN entry UI 130 and receive a PAN entry 410 associated with the debit card from the user 110. The entered PAN on the PAN entry user interface 130 by the user 110 may then be transmitted 412 to the PAN/PIN vault servers 170, possibly along with the identification of the client application context.

The PAN/PIN vault servers 170, responsive to receiving the PAN and optionally the identifier of the client application context from the PAN entry user interface 130, may generate a one-time code associated with the PAN as received from the PAN entry user interface 130. This one-time code may be a hash, such as a one-way hash, of the PAN as received by the PAN/PIN vault servers 170. The received PAN, identifier of the client application context, and/or one-time code may be stored in association with each other in an appropriate database such as in the memory 310 or the PAN/PIN database 330. The one-time code may then be transmitted 414 to the PAN entry user interface 130. The PAN entry user interface 130 may, in turn, transmit 416 the one-time code to the client application user interface 120. The one-time code may next be transmitted 418 from the client application user interface 120 to the client application back-end servers 160.

It will be appreciated that in certain embodiments, the one-time code may be transmitted from the PAN/PIN vault servers 170 to the client application back-end servers 160 via alternate routes and/or via other entities of the architecture 100.

The client application back-end servers 160 may determine a preferred mechanism for notifying the user (e.g., via the client application user interface 120, via an email message to an email address of the user, via an SMS alert or push notification to a mobile phone number of the user, or via a voicemail to a telephone number of the user). A notification for PIN entry may be generated and transmitted 420 from the client application back-end servers 160. The notification may comprise the one-time code and instructions for how to perform PIN entry (e.g., directing the user to the PIN entry UI 140). Upon the user accessing the PIN entry user interface 140, the PIN entry UI 140 may solicit a PIN entry from the user 110. As a result, the user 110 may be provide 422 his or her PIN associated with the debit card to the PIN entry user interface 140.

The PIN entry user interface may transmit 424 the entered PIN, along with the one-time code as received with the notification for PIN entry, to the PAN/PIN vault servers 170. The PAN/PIN vault servers may be able to receive the PIN entry of the user 110 via the PIN entry user interface 140 and associate the PIN with the corresponding PAN of the debit card to be confirmed by using the one-time code as received along with the PIN entry and generated upon receipt of the PAN by the PAN/PIN vault servers 170. The PAN/PIN vault servers 170 may then store the PIN in an appropriate database such as in the memory 310 or the PAN/PIN database 330 in association with the PAN (and identifier of the client application context and/or one-time code). The PAN/PIN vault servers 170 may then generate an authentication request using the PAN and the associated PIN and transmit 426 the authentication request to the debit card processing servers 180 for verification of the debit card PAN and PIN information. The PAN/PIN vault servers may receive 428, an authentication response from the debit card processing servers 180 responsive to the authentication request transmitted 426 to the debit card processing servers 180. The received authentication response may indicate an affirmative or negative confirmation of the authenticity of the PAN and PIN information provided. If a negative confirmation is indicated in the authentication response, then, in certain embodiments, the PAN/PIN vault servers 170 may provide an indication of the negative response to the client application user interface 120 and/or the client application back-end servers 160, either directly or indirectly. In this example interaction 400, we will continue on with an affirmative confirmation of the PAN and PIN information.

PAN/PIN vault servers 170 may next generate a PAN proxy associated with the PIN and PAN information upon receiving an affirmative confirmation of the authenticity of the PIN and PAN information and store 430 the PAN proxy in association with the PAN (and identifier of the client application context, one-time code, and/or PIN) in an appropriate database such as in the memory 310 or the PAN/PIN database 330. In certain embodiments, the PAN/PIN servers 170 may perform one or more algorithms, such as algorithms stored in memory 310, to generate the PAN proxy. In some cases, the PAN proxy may be a fixed length hash, such as a one-way hash, of the PAN. In other cases, the PAN proxy may be a fixed length hash, such as a one-way hash, of the PIN or the PAN and the PIN. In other cases, the PAN proxy may be generated based, at least in part, on one or more database keys and/or indexes, such as an index of insertion of the PAN proxy in the registry of PAN proxy to debit card information database. In some cases, the PAN proxy may be generated based, at least in part, on the session associated with the user 110. In other words, the user session, in combination with the debit card account information, such as the PAN and/or PIN, may be used to generate the PAN proxy.

In certain embodiments, the PAN proxy as generated by the PAN/PIN vault servers 170 may next be transmitted 432 to the directly communicate the PAN proxy to the client application back-end servers 160. This communication may include an identifier that the client application back-end server may be able to use to identify the user 110 associated with the PAN proxy. In one case, this identifier may be the one-time code, as generated at 414 by the PAN/PIN vault servers 170. Therefore, the PAN/PIN vault servers 170 may transmit the PAN proxy along with the one-time code to the client application back-end servers 160. The client application back-end servers 160 may know the association between the one-time code and the identifier of the user 110 based, at least in part, on receiving the one-time code form the client application user interface at 418 with an identifier of the user 110. Therefore, the PAN proxy, as received from the PAN/PIN vault servers 170 may be associated with the identifier of the user 110 using the accompanying one-time code. The PAN proxy in association with the identity of the user 110 may be stored at the client application back-end servers 160, such as in memory 210 and/or the PAN proxy association database 230.

In some alternate embodiments, the PAN/PIN vault servers 170 may transmit the PAN proxy and one-time code to the client application back-end servers 160 indirectly. In this case, the PAN/PIN vault servers 170 may transmit the PAN proxy and the one-time code to the PIN entry user interface 140. The PIN entry user interface 140 may next transmit the PAN proxy to the client application user interface 120. In some cases, the PAN proxy may be received by the PIN entry user interface 140 along with an identifier of the associated client application user interface and/or user 110. The client application user interface 120 may provide the PAN proxy in association with the identity of the user 110 to the client application back-end servers 160. The client application back-end servers, at that point, may store the PAN proxy association with the user, such as in memory 210 and/or the PAN proxy association database 230.

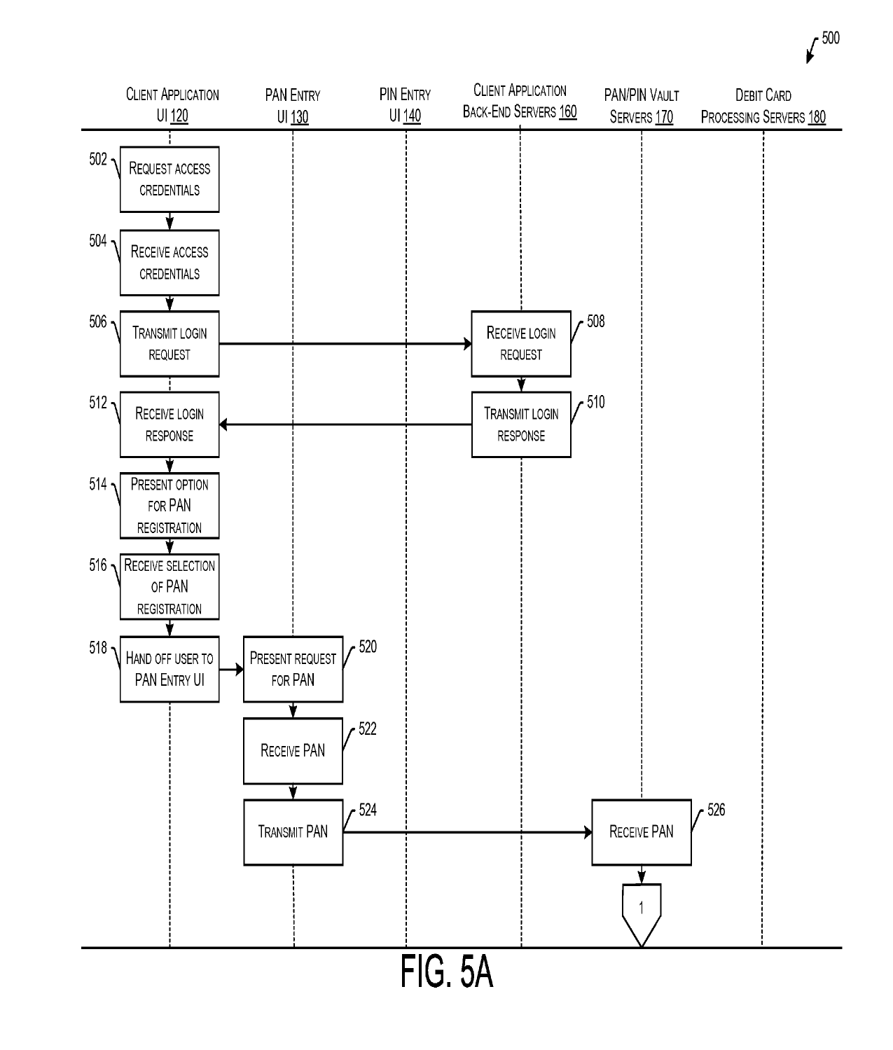

Referring now to FIGS. 5A, 5B, 5C, an example interaction 500 of the elements of architecture 100 is depicted. At block 502, the client application user interface 120 may request access credentials. Responsive to requesting the access credentials, the client application user interface 120 may receive access credentials from the user 110 such as by entry of the access credentials by the user 110. At block 506, the client application user interface 120 may transmit a login request comprising the received access credentials to the client application back-end servers 160.

At block 508, the client application back-end servers 160 may receive the login request. At block 510, a login response may be transmitted by the client application back-end servers 160 to the client application user interface 120. For the purposes of this discussion, the login response is to the affirmative where the user 110 has been able to login successfully to the client application back-end servers, and/or user specific accounts thereon. If the login was not successful, the client application back-end servers 160 may indicate the same to the client application user interface 120, at which point, the client application user interface 120 may request the user 110 to reenter his or her access credentials. At block 512, the login response may be received by the client application user interface 120 from the client application back-end servers 160, as transmitted via the networks 150 or other communicative links.

At block 514, the client application user interface 120 may present an option for initiating registration of a debit card account (by submitting a PAN) for use in the client application. At block 516, the client application user interface 120 may receive an indication of selection of the PAN registration option from the user 110 such as by user input via one or more input/output devices associated with the client application user interface 120. Therefore, the combination of blocks 514 and 516 enable the user to indicate that he or she wishes to perform a PAN registration associated with his or her debit card account.

At block 518, the client application user interface 120 may invoke the PAN entry user interface 130 and may hand-off the session, in certain embodiments, to the PAN entry user interface 130. This hand-off may be performed by invoking a separate thick client or thin client such as a web browser associated with the PAN entry user interface 130. The hand-off may include passing an identifier of the client application context to the PAN entry user interface 130. At block 520, the PAN entry user interface 130 may present a request for the PAN associated with the debit card to be registered. In certain embodiments, the PAN entry user interface 130 may present a region on a user display of the PAN entry user interface 130 in which the user 110 may enter his or her PAN by a variety of input/output devices such as a keyboard, a keypad, a pointing device and keyboard/keypad display, a touchscreen, or the like. In certain embodiments, the PAN entry user interface 130 may enable capture of an image of a debit card (via a scanner or camera device associated with the client device supporting the PAN entry user interface 130). Subsequent processing of the image, such as optical character recognition (OCR) processing, may extract the PAN from the image.

At block 522, the PAN may be received by the PAN entry user interface 130 as a result of entry by the user 110 or image capture by the user 110 followed by subsequent processing to extract the PAN. In some cases, the PAN may have been extracted from an image. When the PAN may have been extracted from an image, the determined PAN may be presented to the user 110, such as on a display screen of the PAN entry user interface 130, and the PAN entry user interface 130 may solicit a confirmation of the determined PAN based upon the one or more images of the debit card account.

At block 524, the PAN may be transmitted from the PAN entry user interface 130 to the PAN/PIN vault servers 170, potentially along with the identifier of the client application context. The transmission of the PAN may be part of one or more data packets carrying the PAN information via the networks 150 or other suitable communicative links between the PAN entry user interface 130 and the PAN/PIN vault servers 170. The data packets may include a payload that includes the PAN as entered by the user 110 and the identifier of the client application context as received from the hand-off from the client application user interface 120. The data packets may further include overhead, such as headers that indicate the address of transmission and routing, as well as transmission integrity checks, such as cyclic redundancy checks (CRC) and/or parity bit checks. In certain embodiments, the transmission may be via the Internet via an HTML and/or Web service call.

At block 526, the PAN in the form of the one or more data packets may be received by the PAN/PIN vault servers 170. Upon receiving the PAN, the PAN/PIN vault servers 170 may generate a one-time code for the purposes of authentication. In certain embodiments, this one-time code may be algorithmically generated, such as using a hash. Therefore, the one-time code may be based, at least in part, on the PAN value. At block 530, the PAN/PIN vault servers 170 may store the PAN and optionally the identifier of the client application context in association with the one-time code in any suitable database such as the memory 310 or the PAN/PIN database 330.

At block 532, the PAN/PIN vault servers 170 may initiate a redirection of the user session, from the PAN entry user interface 130 back to the client application user interface 120, communicating the one-time code in the process. The PAN/PIN entry user interface 130 may, in turn, return the session at block 534 back to the client application user interface 120 and may transmit the one-time code in the process of handing back the session to the client application user interface 120. The client application user interface 120, after receiving the session from the PAN entry user interface 130 with the one-time code, may, at block 536, transmit the one-time code to the client application back-end servers 160.

At block 538, the client back-end servers 160 may identify a preferred notification mechanism for communicating with the user, possibly retrieving this from a profile associated with the user stored in an appropriate database, such as the PAN association database 230, and may generate a notification comprising the one-time code and instructions for accessing the PIN entry user interface 140 and, at block 540, the notification may be transmitted by the client back-end servers 160 to the user via the networks 150 or any other suitable communicative links. At block 542, the user may access the PIN entry user interface 140 and the PIN entry user interface may request a PIN and the one-time code from the user. At block 544, the PIN entry user interface 140 may receive the PIN, such as by interacting with the user 110. The PIN entry user interface 140 may also receive the one-time code that has been associated with the PAN of the debit card account. This one-time code may be entered by the user 110, in certain embodiments, on the PIN entry user interface 140 using a variety of input/output devices, such as a keyboard, a keypad, a pointing device and keyboard/keypad display, a touchscreen or the like.

At block 546, the PIN and the one-time code may be transmitted by the PIN entry user interface 140 via the networks 150 or other suitable communicative links. The PIN and the one-time code may be transmitted as one or more data packets with the payload including the PIN and the one-time code and additional overhead for transmission and integrity checks. At block 548, the PAN/PIN vault servers 170 may receive the PIN and one-time code, and may store the PIN in association with the one-time code (and the PAN and identifier of the client application context) in an appropriate database, such as the PAN/PIN database 330. Based, at least in part, on the one-time code, the PAN/PIN vault servers 170 may retrieve the PAN associated with the one-time code as was generated in block 528.

At block 552, the PAN/PIN vault servers 170 may generate a debit card account authentication request. The authentication request of the debit card account may contain the retrieved PAN and the received PIN. The debit card account authentication request may then be transmitted by the PAN/PIN vault servers 170 to the debit card processing servers 180. At block 556, the authentication request may be received by the debit card processing servers 180. At block 558, the debit card processing servers 180 may process the authentication request. This may involve propagating the authentication request to another one of the debit card processing servers 180, to another debit card processing system or a debit network, or to a card issuer such as a financial institution. A response to the authentication request may then be received.

In the interaction diagram 500 as depicted, an affirmative response of a confirmation of the debit card account is assumed. Such an affirmative response may indicate that the debit card account indicated by the PAN is active and/or that the PIN correctly corresponds to the PAN. Therefore, at block 560, an authentication response may be generated and transmitted by the debit card processing servers 180 indicating an affirmative confirmation of the debit card account.

At block 562, the authentication response may be received by the PAN/PIN vault servers 170. Based on the indication of the successful confirmation of the debit card account of the user 110, the PAN/PIN vault servers 170 may generate a PAN proxy at block 564. As with the one-time code, the PAN proxy may be unique for the PANs and/or the PAN/PIN combinations that are managed by the PAN/PIN vault servers 170. In some cases, a different PAN proxy may be allocated to the same debit card associated with different users 110 and/or different client user interfaces 120. In some embodiments, the PAN proxy may be the same as the corresponding respective one-time code.

At block 566, the PAN/PIN vault servers 170 may store the PAN proxy in association with the PAN, PIN, one-time code, and identifier of the client application context. The storage may be in an appropriate database or data repository, such as one that is stored in memory 310 or the PAN/PIN database 330. At block 568, the PAN/PIN vault servers 170 may initiate a transmission of the one-time code and associated generated PAN proxy ultimately to the client application back-end severs 160, and subsequently may discard the one-time code. This may be via a redirection of the user session from the PIN entry user interface 140 to the client application user interface 120, assuming that the client application user interface session has not expired/terminated and that the PIN entry user interface 140 may accomplish such a hand-off. In such a scenario, the PAN/PIN vault servers 170 may transmit the PAN proxy and associated one-time code to the PIN entry user interface 140. At block 570, the PIN entry user interface 140 may hand the user back to the client application user interface 120, passing along the PAN proxy and associated one-time code. At block 572, the client application user interface 120 may transmit the PAN proxy and associated one-time code to the client back-end servers 160 via the networks 150 or other suitable communicative links.

At block 574, the client application back-end servers 160 may use the received one-time code or the user 110 associated with the client application user interface session to identify the user 110 in an appropriate database, such as the PAN association database 230. Then the client application back-end servers 160 may store the received PAN proxy in association with the user 110, such as in association with the identity associated with the user 110, and subsequently may discard the one-time code. Storing the PAN proxy in association with the identity of the user 110 may enable subsequent transactions using the debit card account. The PAN proxy further may be an indication of successful debit card account confirmation by the PAN/PIN vault back-end servers 170.

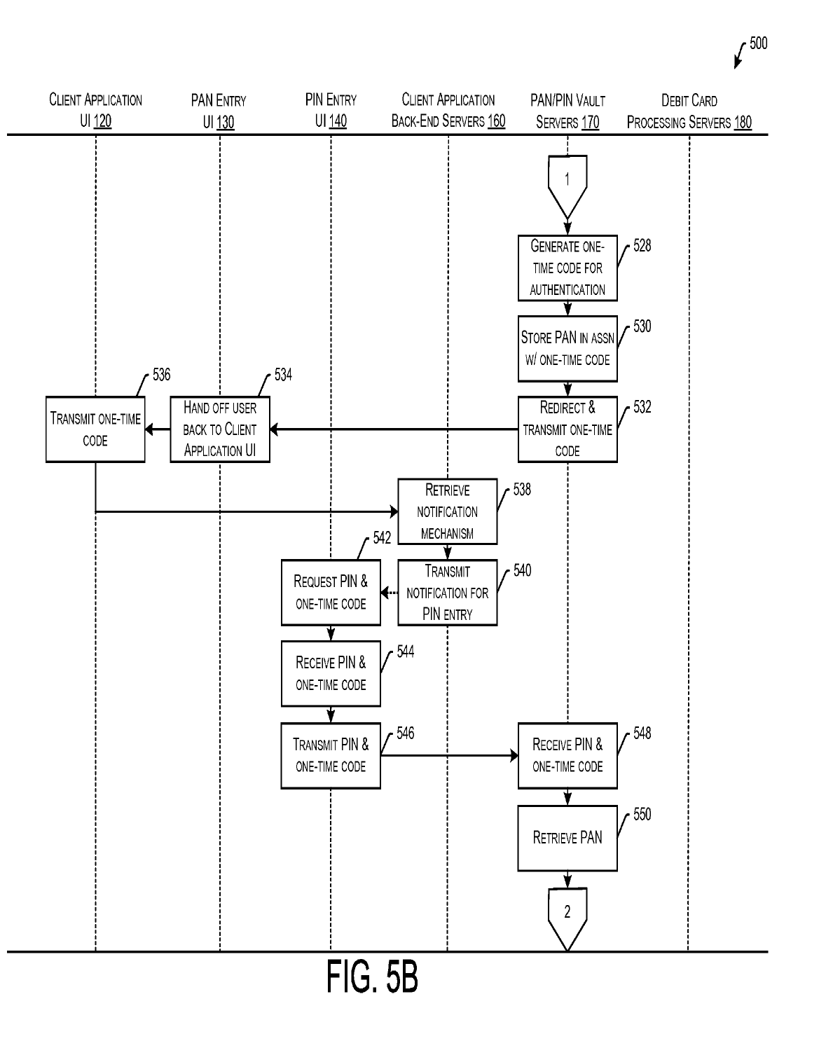

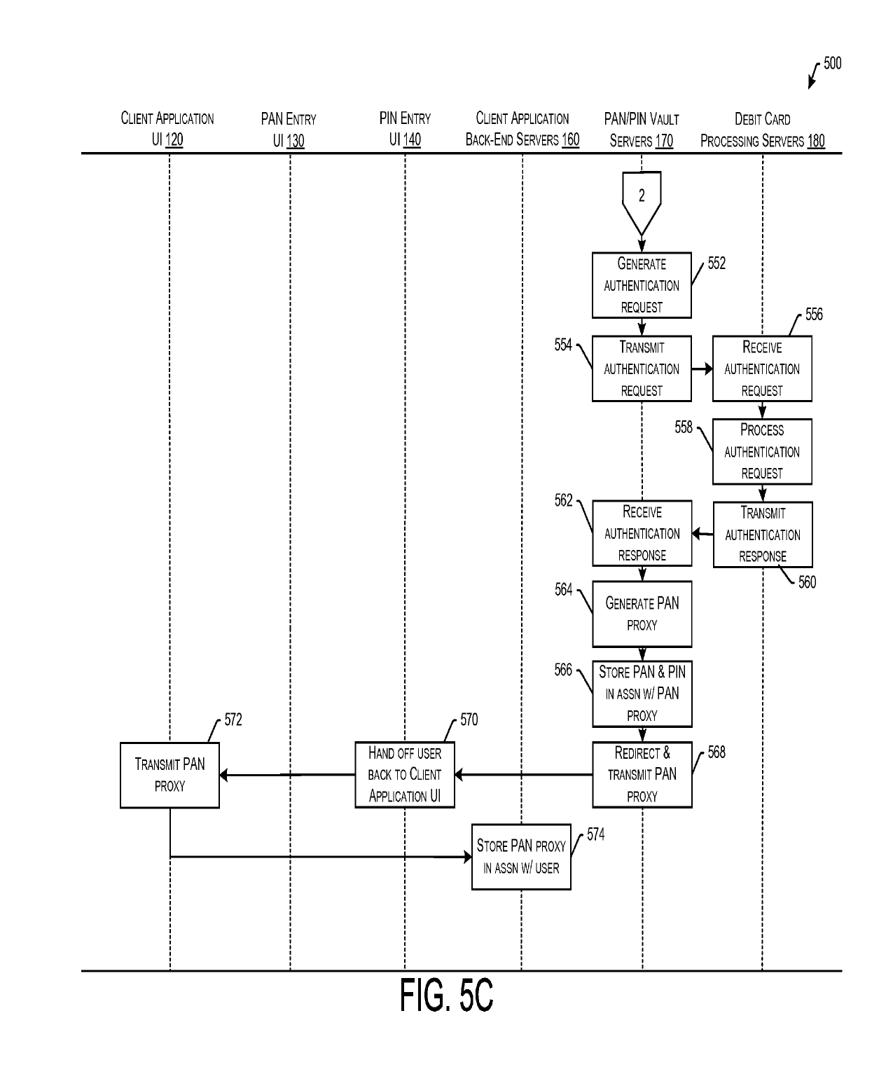

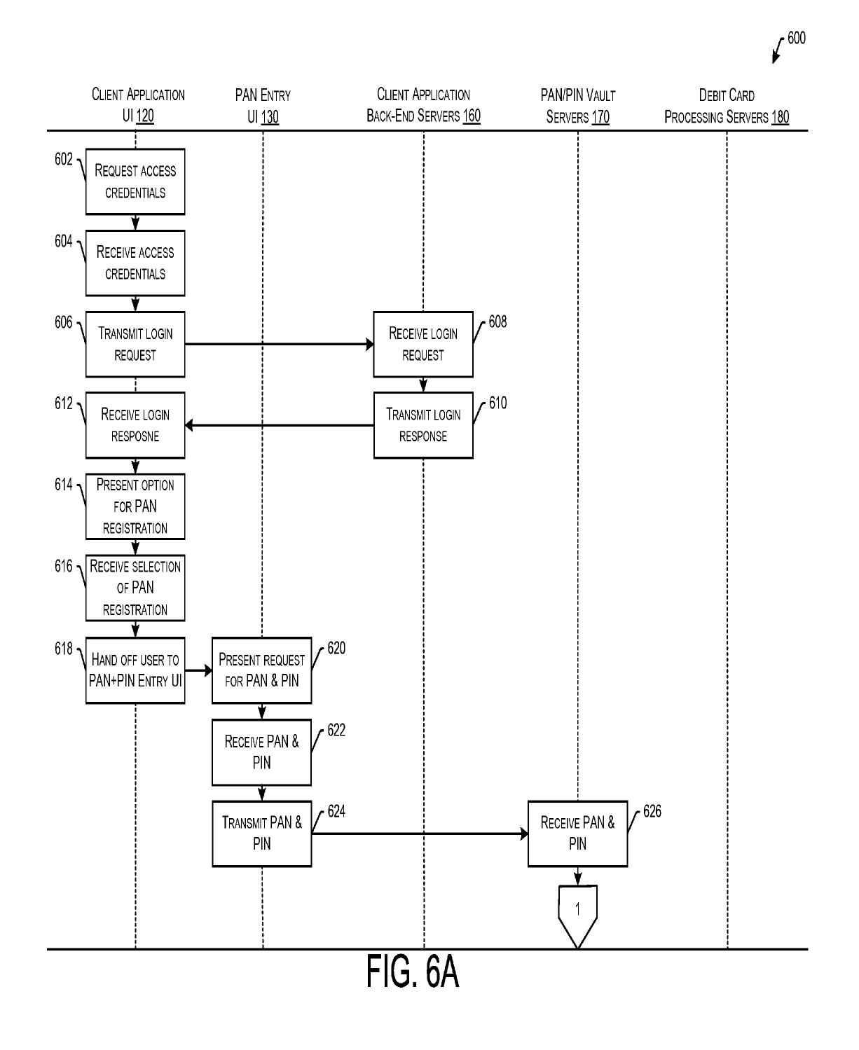

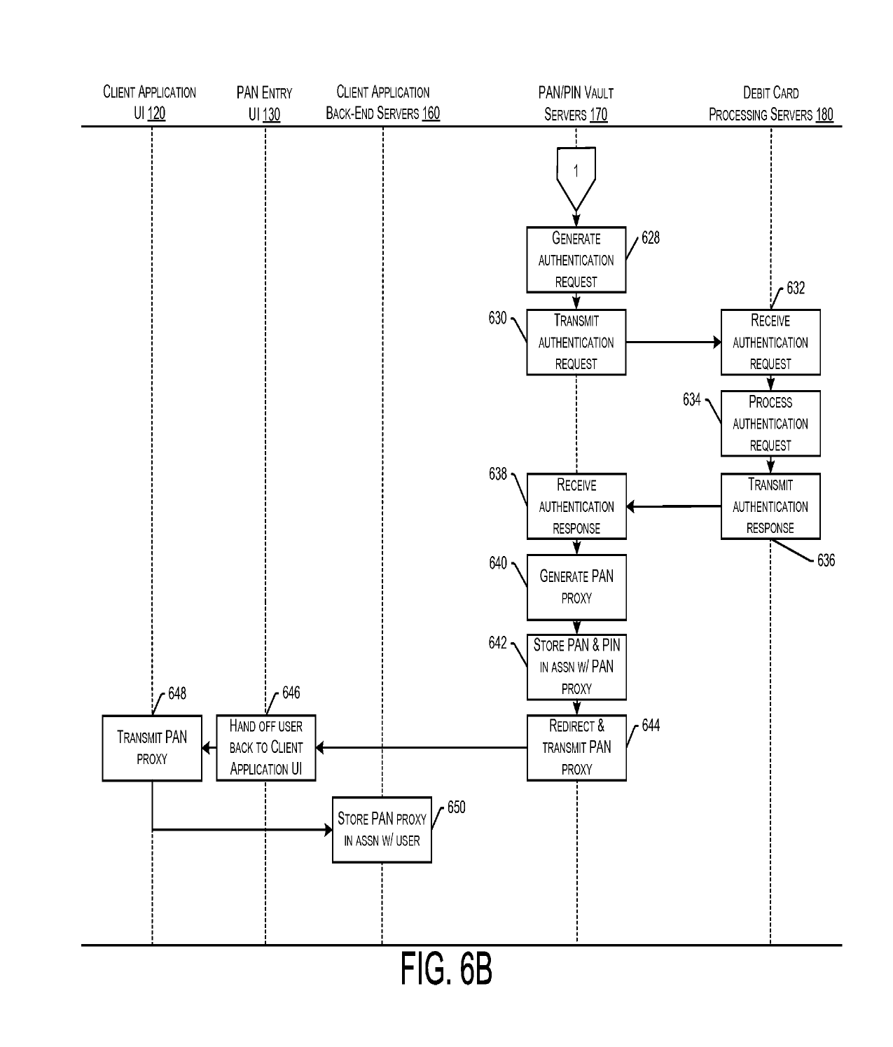

With reference to FIGS. 6A and 6B an example interaction chart 600 depicting a debit card account confirmation in accordance with embodiments of the disclosure is depicted. In this case, the PAN and PIN entry user interfaces may be the same entity and will be referred to, herein, as the PAN entry user interface 130. In other words, the PIN entry user interface 140 is the same as the PAN entry user interface 130.

Blocks 602 through 616 are similar to blocks 502 through 518 of FIG. 5A and in the interest of brevity will not be described in great detail. At block 602, access credentials may be requested by the client application user interface 120. At block 604, the access credentials may be received by the client application user interface 120 from the user 110. At block 606, the client application user interface 120 may transmit a login request comprising the received access credentials to the client application back-end servers 160. At block 608, the client application back-end servers may receive the login request. In this case, the received access credentials may comprise a login and a password. In some other cases, there may be other access credentials associated with the login request, such as biometric data. At block 610, the login response, in this case assumed to be to the affirmative, may be transmitted to the client application user interface 120. At block 612, the login response may be received by the client application user interface 120 from the client application back-end servers 160. At block 614, the client application user interface 120 may present an option for PAN registration. At block 616, the client application user interface 120 may receive a selection of PAN registration from the user 110 using input or output devices associated with the client application user interface 120, such as keyboards and/or touchscreens. At block 618 the client application user interface 120 may then hand-off the user session to a PAN entry user interface 130.

At block 620, a request for the PAN and the PIN may be presented to the user 110 by the PAN entry user interface 130. At block 622, the PAN entry user interface 130 may receive the PAN and PIN as input from the user 110 via any suitable input/output device associated with the PAN entry user interface 130, such as a keyboard, a keypad, a pointing device and keyboard/keypad display, a touchscreen or the like. At block 624, the PAN and the PIN may be transmitted by the PAN entry user interface 130 to the PAN/PIN vault servers 170.

At block 626, the PAN/PIN vault servers 170 may receive the transmitted PAN and PIN as transmitted by the PAN entry user interface 130 via one or more networks 150 or other suitable communicative links.

At block 628, an authentication request may be generated by the PAN/PIN vault servers 170. This authentication request may include the PAN and PIN information that is to be confirmed by the debit card processing servers 180. The authentication request may be in the form of one or more data packets with payloads that include information such as the PAN and the PIN associated with the debit card account to be confirmed.

At block 630, the PAN/PIN vault servers 170 may transmit the authentication request via one or more networks 150 or other suitable communicative links to the debit card processing servers 180. At block 632, the debit card processing servers 180 may receive the authentication request from the PAN/PIN vault servers and may ascertain a PAN and PIN associated with the debit card account therefrom.

At block 634, the debit card processing servers 180 may process the authentication request as received from the PAN/PIN vault servers 170. In one aspect, the debit card processing servers 180 may determine the PAN and the PIN from the authentication request and verify if that PAN and PIN is valid and linked to the debit card account to be confirmed. This may involve propagating the authentication request to another one of the debit card processing servers 180, to another debit card processing system or a debit network, or to a card issuer such as a financial institution.

Based on processing the authentication request, at block 634, the debit card processing servers 180 may generate an authentication response and transmit that authentication response at block 636. The authentication response may be in the form of one or more data packets and transmitted via the networks 150 or other communicative links to the PAN/PIN vault servers 170, indicating the status of the verification of the information associated with the debit card of the user 110 such as the PAN and/or PIN. For the purposes of this discussion, we will assume that the verification is to the affirmative and it is confirmed that the PAN and the PIN is associated with the debit card account of the user 110.

At block 638, the PAN/PIN vault servers 170 may receive the authentication response from the debit card processing servers 180 from the one or more networks 150 or other suitable communicative links. From that authentication response, the PAN/PIN vault servers 170 may determine that the PAN and PIN associated with the debit card have been confirmed as valid.

At block 640, the PAN/PIN vault servers 170 may generate a PAN proxy based at least, in part, on the PAN and/or the PIN information. At block 642, the PAN/PIN vault servers 170 may store the PAN and PIN in association with the PAN proxy in one or more databases or data repositories, such as a database or data repository stored in the memory 310 of the PAN/PIN vault servers and/or the PAN/PIN database 330.

At block 644, the PAN/PIN vault servers 170 may initiate a redirection of the user session from the PAN entry user interface 130 back to the client application user interface 120 and may transmit the PAN proxy at the same time. The redirection and the PAN proxy transmission may be by one or more data packets via the networks 150 or other communicative links between the PAN/PIN vault servers 170 and the PAN entry user interface 130. The PAN proxy may be transmitted along with the one-time code. In certain embodiments, the PAN proxy may be transmitted along with the one-time code. The one-time code may provide a basis for identifying the user 110 associated with the PAN proxy.

At block 646, the PAN entry user interface may redirect the user back to the client application user interface 120. In other words, the PAN entry user interface 130 may transfer the session with the user 110 to the client application user interface 120, communicating the PAN proxy and the one-time code during the transfer. This may be via a redirection of the user session from the PAN entry user interface 130 to the client application user interface 120, assuming that the client application user interface session has not expired/terminated and that the PAN entry user interface 130 can accomplish such a hand-off. At block 648, the client application user interface 120 may transmit the PAN proxy and the one-time code to the client back-end servers 160 via the networks 150 or other communicative links.

The client back-end servers 160 at block 650 may store the PAN proxy in association with the user's identity, such as in the memory 210 or the PAN association database 230. The client back-end servers 160 may further discard the one-time code upon storing the PAN proxy in association with the user's identity. In certain embodiments, the client application back-end servers 160 may have an identification of the user 110 based upon the session at the client application user interface 120. For example, the identification may be based upon the user authentication and/or login into the client application user interface 120 and/or the client application back-end servers 160. The user 110 may alternatively be identified based on the one-time code received with the PAN proxy.

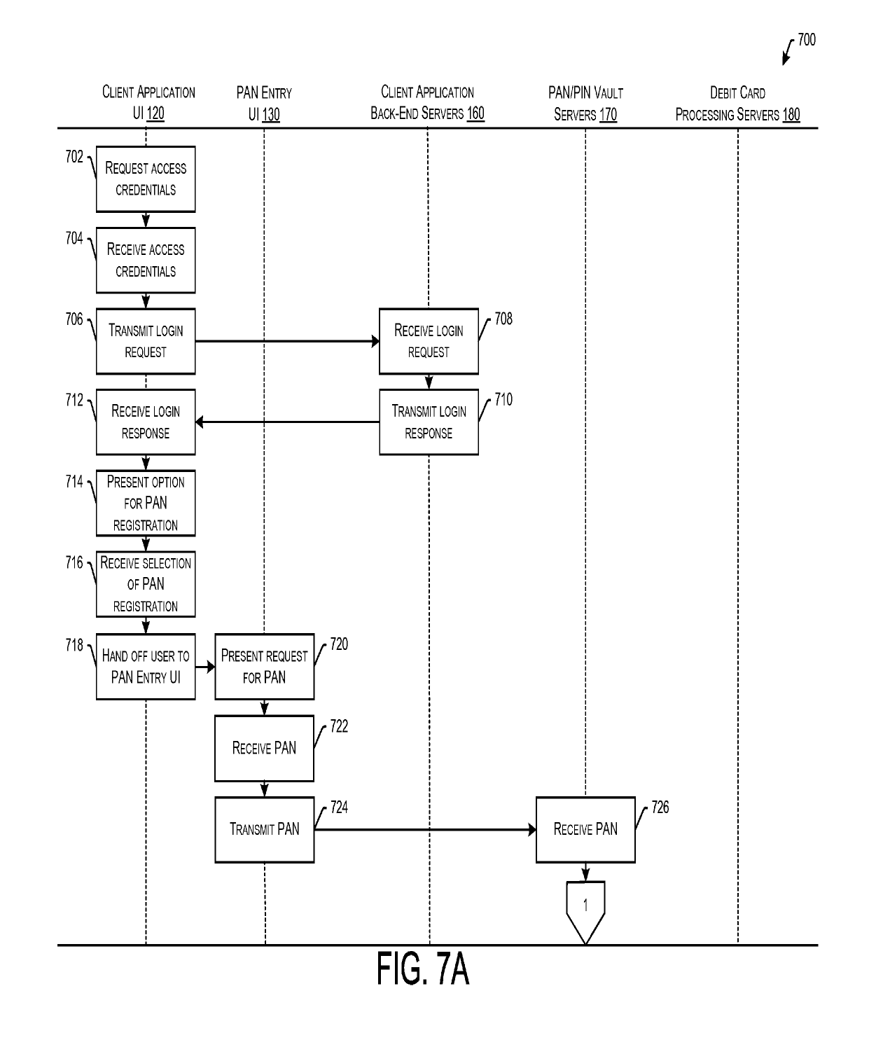

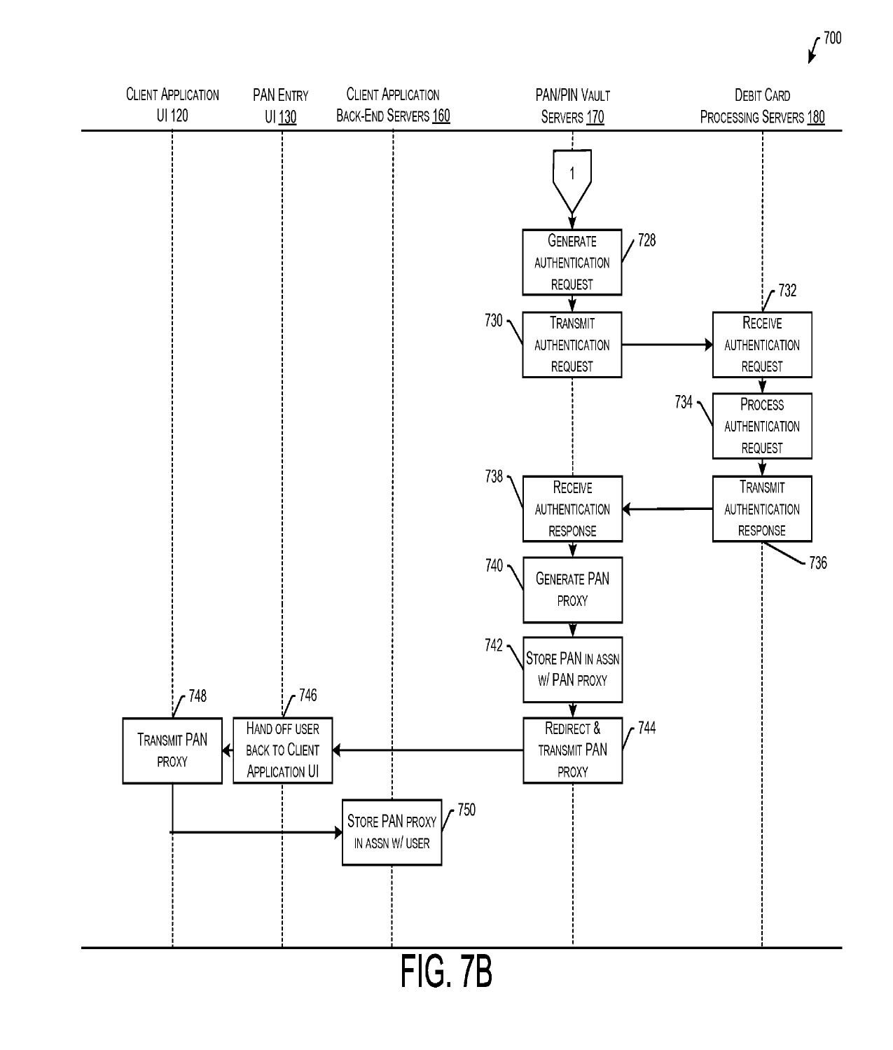

Referring now to FIGS. 7A and 7B. An example interaction 700 of the various entities of architecture 100 to enable debit card account confirmation in accordance with embodiments of the disclosure is depicted. In this particular embodiment, the PAN value associated with the debit card to be confirmed is stored and/or vaulted at the PAN vault servers 170 and the PIN associated with the debit card may not be stored or vaulted.

Blocks 702 through 726 may be similar to blocks 502 through 526 of example interaction 500 of FIGS. 5A, 5B, and 5C. Accordingly, in the interest of brevity, these processes will not be discussed further.

At block 728, an authentication request comprising the received PAN may be generated by the PAN vault back-end servers 170 based, at least in part, on the received PAN of block 726. At block 730, the PAN/PIN vault servers 170 may transmit the authentication request to the debit card processing servers 180.

At block 732, the debit card processing servers 180 may receive the authentication request and ascertain the received PAN therefrom. It should be noted, that in this case, the verification is of the PAN associated with the debit card and not both the PAN and the PIN as in the case of the previous example verifications 500 and 600 of FIGS. 5A, 5B, and 5C, and FIGS. 6A and 6B, respectively. The debit card processing servers 180 may further process the authentication request particularly associated with the PAN to determine if the PAN provided by the user 110 is authentic, at block 734. The debit card processing servers 180 may cooperate with one or more other entities, such as other debit card processing servers 180 to determine if the PAN provided is authentic. In this example, we will discuss the affirmative verification of the debit card PAN associated with the debit card account of the user 110.

At block 736, an authentication response indicating an affirmative confirmation of the PAN associated with the debit card account may be generated and transmitted by the debit card processing servers 180. At block 738, the authentication response may be received by the PAN/PIN vault servers 170. At block 740, the PAN/PIN vault servers 170 may generate a PAN proxy. The PAN proxy may be generated based, at least in part, on the PAN, other information associated with the debit card account, an index associated with a database storing the PAN proxy, or combinations thereof. As discussed above, the PAN proxy may be of a fixed length, such as nine numerical digits long (similar to a PAN).

At block 742, the PAN may be stored in association with the PAN proxy in a variety of databases or data repositories such as a database or data repository stored on the memory 310 or the PAN/PIN database 330. At block 744, the PAN/PIN vault servers 170 may initiate a redirection of the user session from the PAN entry user interface 130 to the client application user interface 120, and may transmit the PAN proxy and the along with the redirection of the session. At block 746, the session may be redirected from the PAN entry user interface 130 to the client application user interface 120, communicating the PAN proxy. At block 748, the client application user interface 120 may transmit the PAN proxy to the client application back-end servers 160 along with an identification of the user 110. The identification of the user may be based, at least in part, on the client session of the client application user interface 120 to which the user 110 had logged in.

At block 750, the client application back-end servers 160 may store the PAN proxy in association with the user. The PAN proxy may be stored in the memory 210 or the PAN association database 230. It will be appreciated that the stored information includes the PAN proxy and not the PIN information in this case. Therefore, in a transaction involving a debit card verified in this manner, the user 110 may have to enter the PIN associated with the debit card during the transaction process.

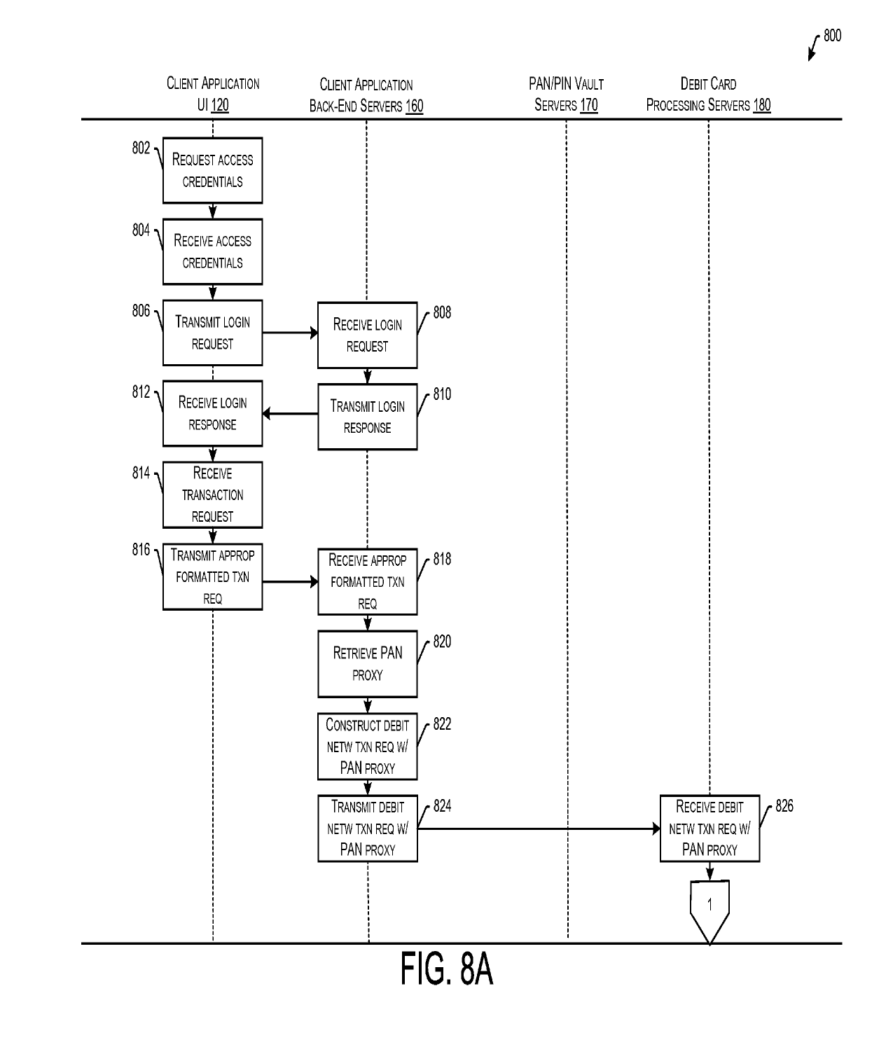

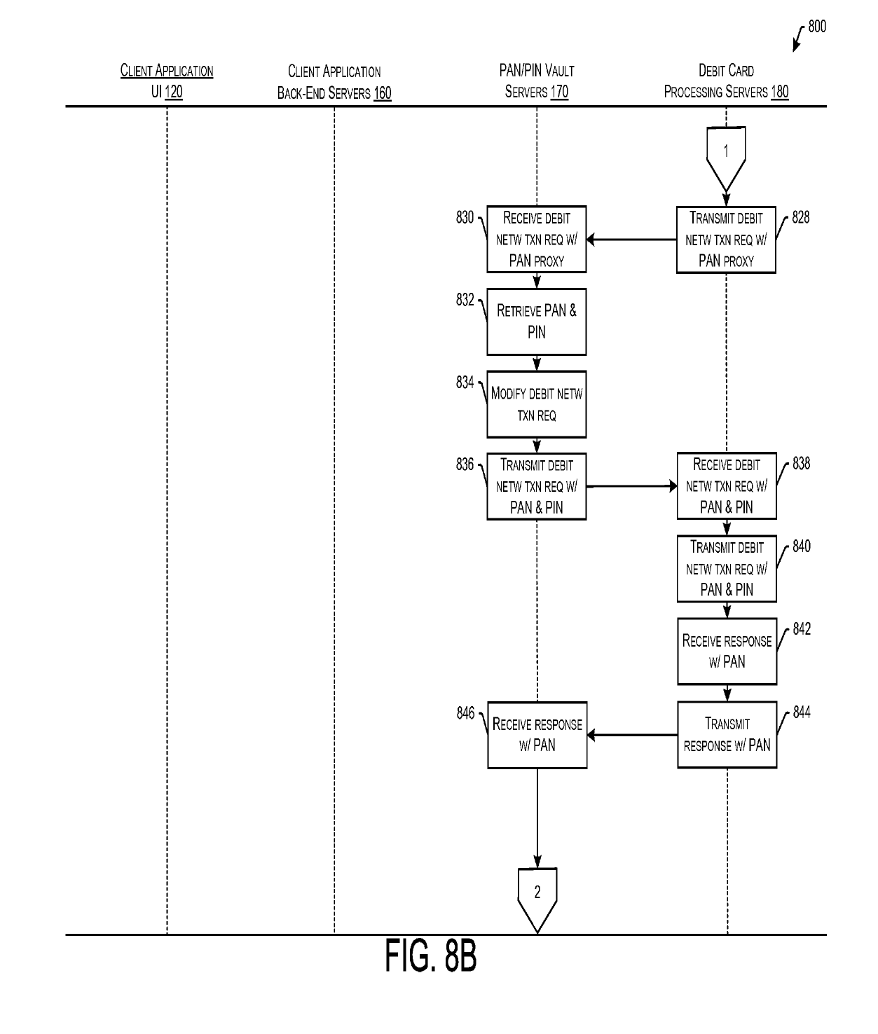

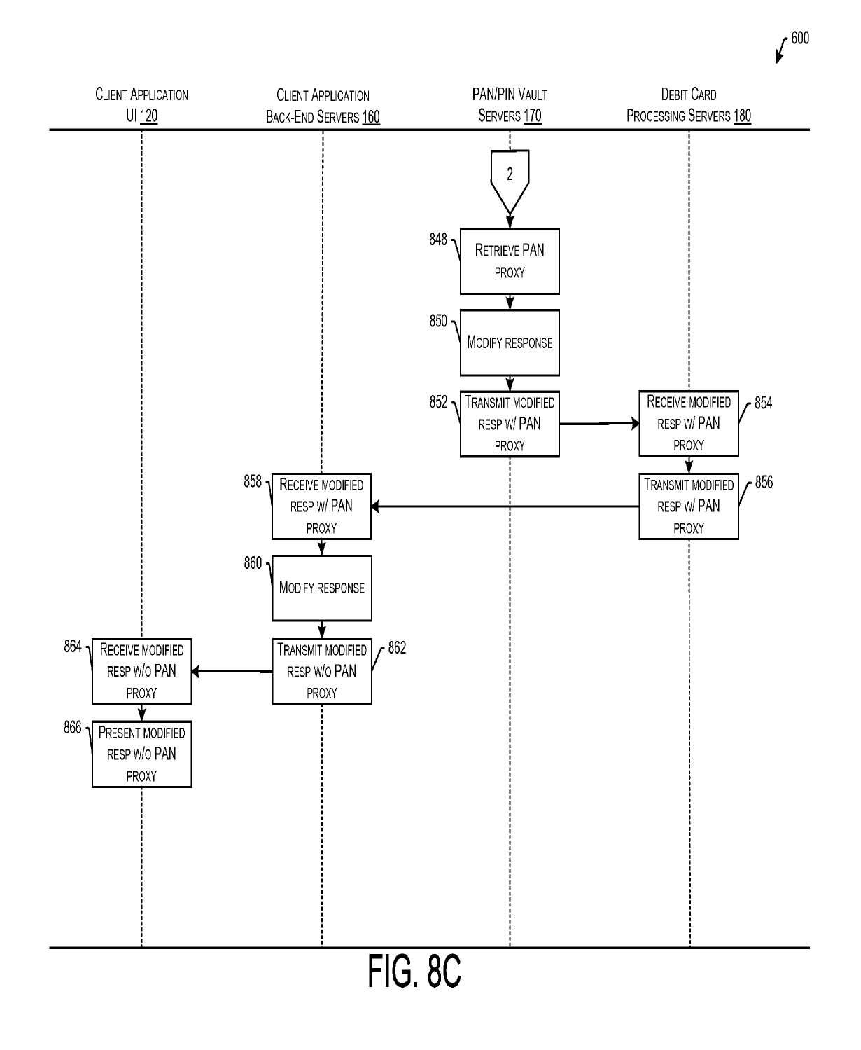

Referring now to FIGS. 8A, 8B and 8C, an example transaction 800 chart is shown in accordance with embodiments of the disclosure for performing a transaction using a debit card account that has been verified by one or more of the interactions 500, 600, or 700 of FIG. 5A-C, 6A-B, or 7A-B, respectively.

At block 802, the client application user interface 120 may request access credentials from the user 110. At block 804, the client application user interface 120 may receive access credentials from the user 110. At block 806, the client application user interface 120 may transmit a login request comprising the access credentials to the client application back-end servers 160. At block 808, the login request may be received by the client application back-end servers 160 and, for the purposes of this discussion an affirmative confirmation of the login will be discussed. Therefore, at block 810 the client back-end servers 160 may transmit a login response confirming the successful login of the user 110 into the client application back-end servers 160, such as into an account associated with the user 110.

At block 812, the client application user interface 120 may receive the login response from the client application back-end servers 160 indicating successful login of the user 110. At block 814, the client application user interface 120 may receive a transaction request from the user 110 such as by an input to the client application user interface 120 by the user via one or more input elements such as a touchscreen, keyboard, pointing device, or the like. For the purpose of this discussion, it is assumed that the transaction request references the debit card account previously confirmed through one or more of the interactions 500, 600, or 700 of FIG. 5A-C, 6A-B, or 7A-B, respectively. The debit card account may be referenced through a selection or by an identifier, which may have been entered. The transaction request may indicate that the debit card account should be either debited or credited. The transaction request may indicate one or more additional elements, such as an amount to be debited or credited, a desired transaction date (if other than the current day), another financial account to correspondingly credit or debit, etc. In some embodiments, the PIN corresponding to the debit card account may be included in the transaction request (if, for example, the PIN is not stored in a data repository such as the PAN association database 230 or the PAN/PIN database 330).

At block 816, the transaction request may be appropriately formatted and transmitted to the client back-end servers 160. The client back-end servers 160 may receive the formatted transaction request and retrieve a PAN proxy corresponding to the confirmed debit card account and associated with the user 110 at block 820 from one or more databases or data repositories such as a database or data repository stored in memory 210 or in the PAN association database 230.

At block 822, a debit network transaction request may be generated by the client application back-end servers 160 including the PAN proxy associated with the user 110. The debit network transaction request may comprise the PAN proxy, an indication of whether the debit card account should be debited or credited, an amount of the debit or credit associated with the amount in the received transaction request, and/or a transaction date. At block 824, the debit network transaction request, including the PAN proxy, may be transmitted by the client application back-end servers 160 via the networks 150 and/or other suitable communicative links to the debit card processing servers 180.

At block 826, the debit card processing servers 180 may receive the debit network transaction request including the PAN proxy. The PAN proxy may indicate to the debit card processing servers 180 that an interaction with the PAN/PIN vault servers 170 may provide the PAN corresponding to the PAN proxy to effect a debit network transaction. While the PAN proxy may have field characteristics of a PAN (e.g., same field length, same character types), a portion of the value, such as an initial character string sequence (e.g., the BIN portion) may uniquely indicate that it is a PAN proxy. There may be other ways of identifying a PAN proxy, such as by lookup or accessing a service. Accordingly, the debit card processing servers 180 may transmit the debit network transaction request with the PAN proxy at block 828 to the PAN/PIN vault servers 170. At block 830, the PAN/PIN vault servers 170 may receive the debit network transaction request with the PAN proxy and based, at least in part, on the PAN proxy retrieve the PAN and PIN associated with the debit card account.

At block 832, the PAN/PIN vault servers 170 may identify the PAN and PIN that correspond to the PAN proxy. This may be by retrieving at least one of these values from the PAN/PIN database 330 based at least in part on the PAN proxy. Alternatively, the PIN may have been received in the debit network transaction request, or the PIN may be unnecessary for the transaction. At block 834, the PAN/PIN vault servers 170 may modify the debit network transaction request, at least by replacing the PAN proxy with the corresponding PAN and optionally including the corresponding PIN. At block 836, the PAN/PIN vault servers 170 may transmit the modified debit network transaction request with the PAN and optionally the PIN to the debit card processing servers 180. At block 838, the debit card processing servers 180 may receive the debit network transaction request including the PAN and optionally the PIN from the PAN/PIN vault servers 170 via the networks 150 or other suitable communicative links.

At block 840, the modified debit network transaction request, including the PAN and optionally the PIN, may be transmitted to a debit network. This may involve transmitting to another one of the debit card processing servers 180, to another debit card processing system, or to a system associated with a card issuer, such as a financial institution. At block 842, the debit card processing servers 180 may receive a response from a debit network, including the PAN, indicating a successful posting of a debit or credit to the debit card account in accordance with the transaction request received from the user 110. The debit card processing servers 180 may identify the processing context for the debit network transaction request and determine that the response should be transmitted back to the originating PAN/PIN vault servers 170. At block 844, the debit card processing servers 180 may transmit a response, including the PAN, indicating the successful posting of the debit or credit to the debit card account of the user 110, to the PAN/PIN vault servers 170.

It will be appreciated that in certain embodiments, there may be a variety of entities associated with the debit card processing servers 180. For example, there may be a debit card processing payment processor, debit card acquiring gateway, and/or debit card processing issuing gateway. Each of these entities may be part of the same system or disparate systems in cooperation with each other. In certain embodiments, the processes of 838, 840, 842, 844 may be performed by a debit card processing issuing gateway.

At block 846, the PAN/PIN vault servers 170 may receive the response as transmitted by the debit card processing servers 180. At block 848, the PAN/PIN vault servers 170 may retrieve a PAN proxy associated with the PAN as indicated in the received response from the debit card processing servers 180. As more than one PAN proxy may be associated with a given PAN (for example, if a different PAN proxy is generated for each use of the PAN from a different client application context), a client application context or session indicator (as a result of receiving the debit network transaction request at block 824) that may be carried through or associated with the debit network transaction processing may be used to determine the correct PAN proxy. At block 850, the PAN/PIN vault servers 170 may modify the response, as received, to replace the PAN with the PAN proxy. At block 852, the PAN/PIN vault servers 170 may transmit the modified response with the PAN proxy to the debit card processing servers 180.

At block 854, the debit card processing servers 180 may receive the modified response with PAN proxy and transmit that modified response at block 856 to the client application back-end servers 160 via the one or more networks 150 and/or other suitable communicative links. The processes of 854, 856 may, in certain embodiments, be performed by cooperation of a debit card processing payments processor and a debit card processing acquiring gateway.

At block 858, the modified response with PAN proxy may be received by the client application back-end servers 160. At block 860, the client application back-end servers may modify the response as received by the client application back-end servers 160 to remove the PAN proxy. This modification may be enabled by the client application back-end servers 160 accessing a database that includes an association between the PAN proxy and the identity of the user 110. The modification may further modify the response for presentation to the user. Alternatively, the modification of the response for presentation to the user 110 may be performed by the client application user interface 120. At block 862, the modified response, without the PAN proxy, may be transmitted by the client application back-end servers 160 to the client application user interface 120.

At block 864, the client application user interface 120 may receive the modified response without the PAN proxy. At block 866, the client application user interface 120 may present the modified response without the PAN proxy to the user 110 as confirmation of the implementation of the transaction requested by the user 110. In some embodiments, the client application user interface 120 may transform the received modified response without the PAN proxy into a form for presentation to the user, if not already received in such a form.

It should be noted, that the interaction 800 may be modified in various ways in accordance with certain embodiments of the disclosure. For example, one or more transactions of the interaction 800 may be eliminated or executed out of order in other embodiments of the disclosure. Additionally, other operations may be added to the interaction 800 in accordance with other embodiments of the disclosure.

Embodiments described herein may be implemented using hardware, software, and/or firmware, for example, to perform the methods and/or operations described herein. Certain embodiments described herein may be provided as a tangible machine-readable medium storing machine-executable instructions that, if executed by a machine, cause the machine to perform the methods and/or operations described herein. The tangible machine-readable medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The machine may include any suitable processing or computing platform, device, or system and may be implemented using any suitable combination of hardware and/or software. The instructions may include any suitable type of code and may be implemented using any suitable programming language. In other embodiments, machine-executable instructions for performing the methods and/or operations described herein may be embodied in firmware.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

While certain embodiments of the disclosure have been described in connection with what is presently considered to be the most practical embodiments, it is to be understood that the disclosure is not to be limited to the disclosed embodiments, but on the contrary, is intended to cover various modifications and equivalent arrangements included within the scope of the claims. Although specific terms are employed herein, they are used in a generic and descriptive sense only, and not for purposes of limitation.

This written description uses examples to disclose certain embodiments of the disclosure and also to enable any person skilled in the art to practice certain embodiments of the disclosure, including making and using any devices or systems and performing any incorporated methods. The patentable scope of certain embodiments of the disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A financial vault system, comprising:
one or more memories that stores computer-executable instructions; and
one or more processors configured to access the one or more memories, wherein at least one of the one or more processors is further configured to execute the computer-executable instructions to:
receive, from a financial application system on behalf of a user, an account number associated with a debit card account;
generate an authentication request comprising the account number;
transmit, to a debit card processing system, the authentication request to confirm the debit card account;
receive, from the debit card processing system and responsive to transmitting the authentication request, an authentication response indicating confirmation of the debit card account;
generate, responsive to receiving the authentication response indicating confirmation of the debit card account, an account number proxy associated with the account number;
store the account number proxy in association with the account number; and
transmit the account number proxy for storage in association with the user in the financial application system.

2. The financial vault system of claim 1, wherein the at least one of the one or more processors is further configured to execute the computer-executable instructions to receive an item of information, wherein the item of information is (i) associated with the debit card account, (ii) not revealed on a card associated with the debit card account, and iii) known to the user and an issuer of the debit card account and wherein the authentication request further comprises the item of information.

3. The financial vault system of claim 2, wherein the item of information is a personal identification number.

4. The financial vault system claim 2, wherein the account number is received from a first system, and wherein the item of information is received from the financial application system.

5. The financial vault system of claim 1, wherein the account number proxy is further associated with the financial application system.

6. The financial vault system of claim 5, wherein the at least one of the one or more processors is further configured to execute the computer-executable instructions to store an indication of the financial application system in association with the account number proxy.

7. The financial vault system of claim 1, wherein the account number proxy is transmitted to (i) the financial application system or (ii) a system other than the financial application system for further transmission to the financial application system.

8. The financial vault system of claim 1, wherein the at least one of the one or more processors is further configured to execute the computer-executable instructions to:
receive, on behalf of the user and the financial application system, a transaction request, wherein the transaction request comprises the account number proxy;
identify, based at least in part on the account number proxy, the account number;
generate a modified transaction request, wherein the modified transaction request comprises the account number;
transmit, to the debit card processing system, the modified transaction request.

9. The financial vault system of claim 8, further comprising:
receive, from the debit card processing system responsive to transmitting the modified transaction request, a transaction response corresponding to the transaction request, wherein the transaction response comprises the account number;
identify, based at least in part on the account number, the account number proxy;
generate a modified transaction response, wherein the modified transaction response comprises the account number proxy;
transmit, for delivery to the financial application system, the modified transaction response.

10. A method, comprising:
receiving, by a financial vault system comprising one or more computers from a financial application system on behalf of a user, an account number associated with a debit card account;
generating, by the financial vault system, an authentication request comprising the account number;
transmitting, by the financial vault system to a debit card processing system, the authentication request to confirm the debit card account;
receiving, by the financial vault system from the debit card processing system and responsive to transmitting the authentication request, an authentication response indicating confirmation of the debit card account;
generating, by the financial vault system responsive to receiving the authentication response indicating confirmation of the debit card account, an account number proxy associated with the account number;
storing, by the financial vault system, the account number proxy in association with the account number; and
transmitting, by the financial vault system, the account number proxy for storage in association with the user in the financial application system.

11. The method of claim 10, further comprising:
receiving, by the financial vault system, an item of information, wherein the item of information is (i) associated with the debit card account, (ii) not revealed on a card associated with the debit card account, and iii) known to the user and an issuer of the debit card account and wherein the authentication request further comprises the item of information.

12. The method of claim 11, wherein the item of information is a personal identification number.

13. The method of claim 11, wherein the account number is received from a first system, and wherein the item of information is received from the financial application system.

14. The method of claim 10, wherein the account number proxy is further associated with the financial application system.

15. The method of claim 14, further comprising storing, by the financial vault system, an indication of the financial application system in association with the account number proxy.

16. The method of claim 10, wherein the account number proxy is transmitted to (i) the financial application system or (ii) a system other than the financial application system for further transmission to the financial application system.

17. The method of claim 1, further comprising:
receiving, by the financial vault system on behalf of the user and the financial application system, a transaction request, wherein the transaction request comprises the account number proxy;
identifying, by the financial vault system based at least in part on the account number proxy, the account number;
generating, by the financial vault system, a modified transaction request, wherein the modified transaction request comprises the account number;
transmitting, by the financial vault system to the debit card processing system, the modified transaction request.

18. The method of claim 17, further comprising:
receiving, by the financial vault system from the debit card processing system responsive to transmitting the modified transaction request, a transaction response corresponding to the transaction request, wherein the transaction response comprises the account number;
identifying, by the financial vault system based at least in part on the account number, the account number proxy;
generating, by the financial vault system, a modified transaction response, wherein the modified transaction response comprises the account number proxy;
transmitting, by the financial vault system for delivery to the financial application system, the modified transaction response.

19. A financial application system, comprising:
one or more memories that stores computer-executable instructions; and
one or more processors configured to access the one or more memories, wherein at least one of the one or more processors is further configured to execute the computer-executable instructions to:
receive, on behalf of a user, an account number proxy associated with a debit card account, wherein the account number proxy indicates successful confirmation of the debit card account by a financial vault system;
store the account number proxy in association with the user;
receive, subsequent to storing the account number proxy, a transaction request on behalf of the user;
identify, based at least in part on the transaction request, the user;
determine, based at least in part on storing the account number proxy in association with the user and the identification of the user, the account number proxy;
generate, responsive to receiving the transaction request, a debit network transaction request corresponding to the transaction request, wherein the debit network transaction request comprises the account number proxy;
transmit the debit network transaction request;
receive, responsive to transmitting the debit network transaction request, a debit network transaction response, wherein the debit network transaction response comprises the account number proxy; and
transmit, for presentation to the user, an indication of the debit network transaction response.

20.-22. (canceled)

23. The financial application system of claim 19, wherein the at least one of the one or more processors is further configured to execute the computer-executable instructions to receive a one-time code associated with the user, wherein the one-time code corresponds to the account number of the debit card account.

24.-28. (canceled)
